(19) United States
(12) Patent Application Publication
(10) Pub. No.: US 2002/0055870 A1
(43) Pub. Date: May 9, 2002

(54) System for human capital management

(76) Inventor: Roland R. Thomas, Highlands Ranch, CO (US)

Correspondence Address: Santangelo Law Offices, P.C., Third Floor, 125 South Howes, Fort Collins, CO, 80521, US

(21) Appl. No.: 09/877,474

(22) Filed: Jun. 8, 2001

Related U.S. Application Data
(60) Provisional application No. 60/210,206, filed on Jun. 8, 2000.

(51) Int. Cl. G06F 17/60

(52) U.S. Cl. 705/10

(57) ABSTRACT

An automated human resource assessment system having computer-based processes. Specifically, programmable hardware or software system having standardized profile parameters that may be combined with database management or statistical techniques to screen, evaluate, or match individuals with defined profile parameters.

This application claims the benefit of United States Provisional Application No. 60/210,206 filed on Jun. 8, 2000, hereby incorporated by reference herein.

### BACKGROUND

Generally, an automated human resource assessment system having computer-based processes. Specifically, programmable hardware or software system having standardized profile parameters that may be combined with database management or statistical techniques to screen, evaluate, or match individuals with defined profile parameters.

Traditionally, human resource assessment has been done by individuals within an organization who describe various attributes related to a position or circumstance. For example, a human resource procurement person may describe requirements for an open job, advertise for individuals, or source candidates through third parties, accumulate resumes of candidates, review the resumes to determine the qualifications of a candidate versus the job requirements, select the best-matching candidates, interview the best-matching candidates, and select a final candidate for a job offer.

Because of the substantial benefits that can result from the use of human resource assessment technology to help select individuals having particular characteristics that correspond to a particular profile there has been extensive commercial interest in developing human resource assessment technology. Despite attempts to update existing human resource assessment technology a long felt but unresolved need remains for standardized methods and devices to screen, evaluate, or match individuals with defined profile parameters. As such, substantial problems with present human resource assessment technology remains unresolved.

A significant problem with conventional technology for human resource assessment may be a dependency upon a combination of text information, such as text resumes, as a source of data regarding the candidate's qualifications for a specific position and electronic key word searches as a method for extracting and analyzing the data. The process sequence includes the accumulation of resumes; the conversion of resume content into a standardized digital format; the extraction of data on qualifications, education and experience of the candidate through key word searches; the accumulation, normalization and comparison of data from different candidates against the stated requirements of a particular job; and the selection of qualified candidates from this comparison through screening and ranking.

The principal weakness of this approach to human resource procurement automation processes is the nature of the original data source, text information, or resume. Resumes, for example, are prepared by job candidates. Candidates are motivated to present themselves in the best possible fashion so as to get the best job with the most authority and highest compensation. Since there is no requirement for standardization of the content or presentation of resumes, they end up being highly subjective and incomplete presentations of experience and qualifications. Information that supports the image an individual wants to portray is included—whereas other information is omitted. In some cases, individuals may over represent or under represent certain aspects of their character, their qualifications, or their experience.

Another significant problem with conventional technology for human resource assessment may be the reliance upon text information, for example resumes, as the central data source in existing approaches to automating the human resources assessment or procurement processes. First, it may be difficult to digitize data on qualifications, education and experience. Digitizing involves converting the raw resume data into a standard data format, typically ASCII, that is recognized by the database engine used in the automation process. Original text information or resumes can come in either paper or computer data file formats such as a Microsoft Word document file. In the case of a paper document, the digitization process involves scanning the document, applying optical character recognition (“OCR”) technology to convert the paper document into a text file. In many cases, the OCR process results in errors in spelling and punctuation that affect the meaning of the text and deteriorate the quality of the data. In the case of a computer data file format, the format will often have to be converted to the standard text file format used by the automation program.

Another significant problem with conventional technology for human resource assessment may be the extraction of discrete data on an individual's characteristics, qualifications, education, or experience. For automation to occur, data, such as an individual's educational background, has to be identified, interpreted, extracted, translated to a standard presentation and inserted in a new database in a database format. Conventional technology searches for key words or phrases that indicate the nature of the data contained in each portion of the text information or resume. Once key words or phrases are found, additional instructions govern the extraction of data and insertion into a database. For example, if a text string contains the word “University”, the software may have rules that interpret this as relating to university-level education and extracts the text string for insertion in the portion of the database relating to education. Since resumes use a variety of approaches for expressing information on qualifications, education and experience, each of these approaches has to be anticipated and programmed. Unfortunately, it is almost impossible to anticipate all the variations possible resulting in incorrect or incomplete data extraction. Since the data extraction process is prone to error, human intervention is required to assure database quality. This intervention takes the form of review of the database and comparison with the original resume. This intervention is time-consuming and expensive. Even if the data extraction process goes smoothly, the resulting database will be incomplete due to the lack of a standardized and complete presentation of information on the original resume. Again, human intervention may be required to ascertain additional information and interpret qualifications based on the information provided.

Another significant problem with conventional technology for human resource assessment may be that using text file information or text file resumes as data is the normalization of data once it has been extracted and stored in a database. Since the original information will be presented by different people in different ways, the challenge is to effectively normalize the data. Normalization is the process of rendering data so that it is directly comparable from one candidate to another. For example, one candidate may have written that he has “five years experience programming in C++”. Another candidate may have written that she has “C++—Advanced Level”. Both these candidates may have the same level and duration of experience, however it is difficult to ascertain from the text that this is the case. Normalization requires artificial intelligence approaches, however the accuracy in many cases is very low.

Still another significant problem with conventional technology for human resource assessment may be that text file information or text file resumes lack standardization by industry. Certain industries require or focus on different skill-sets and other qualifications as being primary profile parameters or hiring indicator. Since text file resumes are prepared in a subjective fashion, it is difficult to apply the objective standards for hiring in a given industry and by job descriptions.

Yet another significant problem with conventional technology for human resource assessment may be that text file information or text file resume automation approaches produces data that is incomplete, inaccurate and non-standardized, the automation of screening and matching of candidates to positions is greatly compromised. Screening is the evaluation of candidates to see if they meet a basic set of requirements for a position. Matching is the qualitative and quantitative matching of a candidates' qualifications with the overall requirements of a position. Using test file information or text file resume-based databases, automated screening processes produces poor results because of the poor quality of data. Candidates selected by the screening process may not have the qualifications needed and vice-versa. Generally, the screening thresholds have to be set low or run the risk of rejecting qualified candidates, thus greatly increasing the number of resumes that have to be reviewed by human resources people, thus increasing the time and cost needed to arrive at a pool of qualified candidates. Further, once the pool of qualified candidates is defined, the matching process is almost entirely manual due to the lack of rigorous data with which to quantitatively rank candidate's qualifications versus the requirements of a position.

The present invention addresses each of these problems relating to human resource assessment and discloses technology that provides practical solutions.

### SUMMARY OF INVENTION

Accordingly, the broad goal of the invention, including but is not limited to products and services which can be provided by digitalReach™, is to provide both devices and methods for human resource assessment. While various examples of embodiments of the invention are provided which relate to human resource procurement, the examples are not meant to limit the scope of the invention solely to devices or methods illustrated by these examples. It can be understood that the invention may be applied to a wide variety of applications in the human resource assessment or profiling industries. Naturally, as a result of the several different and potentially independent aspects of the invention, the objects of the invention are quite varied.

A broad object of a particular embodiment of the invention can be to address the problems of inconsistency in information text or resume formats by providing a consistently formatted interface for entering data on characteristics, qualifications, education, or experience, or the like. This format is based upon a standardized profile parameters or standardized skill sets with guidelines for entering characteristics, experience, qualification levels, or the like. A candidate entering data in this manner has a basis for self-evaluation that leads to consistent data regarding the various characteristics, qualifications, or experience.

Another broad object of a particular embodiment of the invention can be to avoid the problems of poor data quality or conversion of information text or file formats by adopting a standard data entry approach to capturing aspects of an individual's characteristics, qualifications, education, or experience. Moreover, the data is placed into a database with each aspect of an individual's character or background placed into a specific database field. Each of these fields can then be used in data processing procedures to automate analysis of candidates in the screening and matching process.

Another broad object of a particular embodiment of the invention can be to avoid the need to normalize data as the data is normalized to begin with. Data normalization in the invention, or digitalReach™ embodiment of the invention, can be enhanced by providing guidelines or instructions to the user entering data about his or her experience.

Another broad object of a particular embodiment of the invention can be to maintain flexible relationships with the central database providing the capability of different reporting or presentation of the individual characteristics, profiles, qualifications, education, or experiences depending on the requirements of a specific industry type or based upon specific job categories, or the like.

Another broad object of a particular embodiment of the invention can be to provide precision screening of individuals as the data contained in the inventions database can be complete, standardized, or normalized. Moreover, candidates can be ranked in a quantitative fashion according to their qualifications vis-a-vis the requirements of the contextual interface, contextual environment, such as a job position. This ranking extends not only to technical skills, for example, duration or level of competency in a programming language, but also personal characteristics or skills such as management or leadership ability. The resulting benefit can be that the screening or ranking process can be highly objective with a high level of accuracy. This may allow human resources persons to focus more effort on the final, subjective process of finding the best “fit” among qualified candidates in terms of such attributes as personality.

Another broad object of a particular embodiment of the invention can be to reduce internal personnel due to automated matchmaking, Profit and Loss (P&L) objectivity throughout the selection and negotiation process, and to provide incremental opportunities and capacity with extension beyond existing resource pool through the digitalReach™ global resource pool.

Naturally further objects of the invention are disclosed throughout other areas of the specification and claims.

### BRIEF DESCRIPTION OF THE DRAWINGS

The following descriptions and referenced drawings pertain to selected preferred embodiments of the invention. Naturally, changes may be made to the disclosed embodiments while still falling within the scope and spirit of the present invention.

FIG. 1 shows a flow chart diagram of a particular embodiment of the invention.

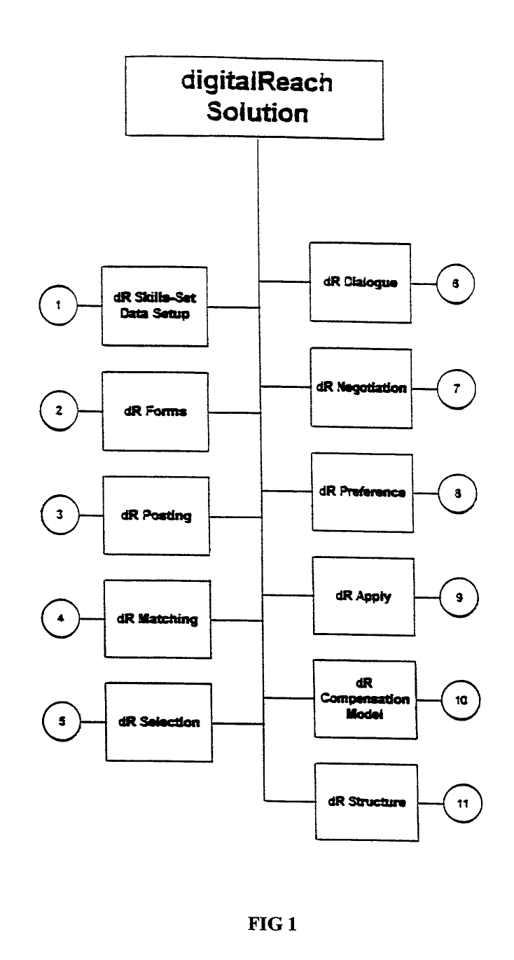

FIG. 2 shows a flow chart diagram of a particular embodiment of the invention relating to a skills set data setup architecture.

FIG. 3 shows a flow chart diagram of a particular embodiment of the invention relating to a forms architecture.

FIG. 4 shows a flow diagram of a particular embodiment of the invention relating to a posting architecture.

FIG. 5 shows a flow diagram of a particular embodiment of the invention relating to a matching architecture.

FIG. 6 shows a flow diagram of a particular embodiment of the invention relating to a selection architecture.

FIG. 7 shows a flow diagram of a particular embodiment of the invention relating to a dialogue architecture.

FIG. 8 shows a flow diagram of a particular embodiment of the invention relating to a negotiation architecture.

FIG. 9 shows a flow diagram of a particular embodiment of the invention relating to a preferences architecture.

FIG. 10 shows a flow diagram of a particular embodiment of the invention relating to a apply architecture.

FIG. 11 shows a flow diagram of a particular embodiment of the invention relating to a compensation model architecture.

FIG. 12 shows a flow diagram of a particular embodiment of the invention relating to a multiple organizational units architecture.

### DETAILED DESCRIPTION OF THE PREFERRED EMBODIMENTS

As can be understood from the description and the drawings the invention relates programmable devices and methods for human capital management. Particular embodiments of the invention may include an enterprise software solution, which can enable organizations to more efficiently and effectively manage their internal and external workforce. The workforce management software application can streamline processes for organizations and allows an extended enterprise i.e., employees, partners/suppliers and customers, view of their human capital resources. Certain embodiment of the invention are developed to significantly enhance the ability of companies to:

1. Manage human resource workforce planning

2. Manage human resource acquisition including recruitment and placement

3. Manage human resource development including performance and retention

4. Manage human resource effectiveness including measurement and valuation

Particular embodiments of the inventions incorporate and capitalize on the Internet or Intranet as the backbone for all transactions and communications that are integral to the invention. The invention allows creation of Job Requests using information from the Skills Library, a pre-populated, comprehensive database of industry standard skills. Employees and candidates use the same skills database to complete detailed Applicant Profiles, identifying their business experience, work-related skills, education, and accomplishments. To make the invention more effective, predefined Applicant Profiles and Job Descriptions are available to assist in the creation process and may be further customized as needed. Empowering employers and employees to use the same skill standards allows invention to precisely match Applicant Profiles and Job Requests, eliminating the chore of sorting through hundreds of resumes. Ultimately, the invention can integrate the entire corporate recruiting supply-chain.

The invention can eliminate the traditional text based resume and replaces it with a standardized profile, which is made up of organized skills and content attributes. This allows for a precise and rapid selection of individuals for a contextual interface or contextual event, such as jobs or contracts. The invention can permit human resource assessors, such as corporate human resource personnel, line managers, executive recruiters and personnel agencies to fill temporary and permanent positions faster with less procurement and service cost by accessing the digital data bank of professional consultants and job applicants by precisely posting the skills and logistics desired. The application allows digital capture and tracking of human resource skills and logistics requirements for a particular contextual interface, contextual environment, job posting, or for candidate's career objectives.

The invention provides a qualitative and quantitative match. Users may set preferences for preferred vendors, minorities affiliates, or the like. Transaction data is then re-useable and provides history and empirical data for comparison and optimization. Armed with this information both the supply and demand users can be objective throughout the planning, acquisition, development and measurement process.

Embodiments of the invention, including the digitalReach embodiment, can provide skill libraries organized by industry and segments. It is an information bank containing preset skills including: personal skills (people and management), business process (business competencies and functions), industry (sectors), software (applications), and equipment (tools, hardware) knowledge. The Skills Library invention drives consistency and ensures that Job Requests and Applicant Profiles use the same terminology.

Embodiments of the invention, including the product and service suite, can be distributed in a variety of ways including:

1. Internet open market based: with end-users and suppliers visibility and matching of professional workers' demand and supply of permanent, consulting, temporary, contractual short and long-term engagements.

2. Intranet based: uses both Intranets and the Internet to provide matching of demand requirements for workers inside and outside the company. Particular embodiments of the invention, including digitalReach applications, can be presented via user functional and industry sector specific customized and integrated portals.

The invention can provide a solution that includes extended enterprise i.e., employers, supplier/partner and customers by assisting them with increased productivity as human resource skills are optimized across the human capital supply chain. The invention allows digital capture and tracking of the knowledge human capital profile(s). High volume of skills-set selection specific intelligence can be built in to the invention and will match best fit, and best trade, for individual and project requests. Preset acceptance and bidding options are based on preferences and capability. The invention can also create alerts for preferred opportunities and alert method is specifiable. Re-useable transaction data provides history and statistics.

Embodiments of the invention include workforce planning application designed to allow enterprises and professional service organizations to manage their workforces in a strategic manner. This include workforce planning by breaking down projects into specific tasks and allocating human resources overtime. This invention can also allow for creating a corporate skills inventory, performing a skills gap analysis for any grouping within the enterprise, generating a standardized and normalized list of corporate job descriptions and generating statutory compliance reports.

Applicants can maintain their skills-set and look for and find their next career opportunity. They will receive assistance and information regarding career and industry trends. Support for multiple profiles is built-in, as are inactive, testing and live modes. These modes allow for more accurate profile construction, as the user may see results of a specific profile as it is weighed against the inventions skills-set and then make any necessary modifications. In active mode, the invention can match for best jobs, then best compensation. Candidate profiles, when inactive, will obtain alerts for best available jobs. The digitalReach skills-set library is industry sector specific, allowing a broad scope of utilization.

Related resources, white papers and sector specific news and articles will be made available within the invention's database environment. The invention can also store transaction data (including, but not limited to: industry recourses, articles, white papers and links to related sites, standard reports from company transactions, standard reports from global data, reports on inter-company division and business-unit activities, and reports on your preferred vendor and affiliates network) is maintained in the database for valuable demographic, logistics, skill, price, salary and trend information. Users may customize reports from the data, track company transactions and activity, obtain global trends and economics data, and schedule reports for daily, weekly, and monthly delivery. Objectives are thus to stay in touch with your industry, gain awareness of your demand or supply transactions and activities, obtain skills, price and compensation knowledge before committing to a deal, and follow generic demographic, skill-set and industry sectors trends and shifts.

The value proposition of the invention include:

1. Reduce planning, acquisition, development and retention costs by automation human capital management process

2. Manage retention and define Knowledge Workers' capabilities

3. Reduce contracted consultants' labor costs

4. Implement processes that streamline the internal and external marketing of services by integrated automation of the entire staffing supply chain process.

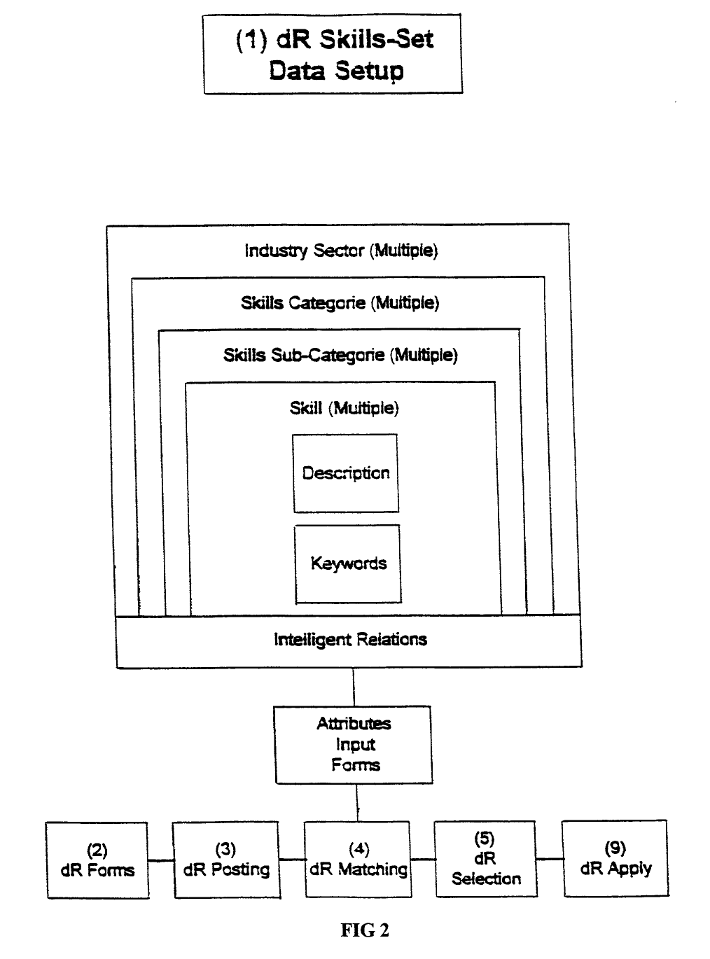

Referring to FIG. 2, it can be understood that particular embodiments of the invention can include content loaded predefined skills-set libraries used as the basis for all the digitalReach solutions, such as forms (2), posting (3), matching (4), selection (5), and apply (9), to create an accurate matching process. Specifically, this invention serves as a set of multiple skills-set libraries, sorted by categories and sub-categories, and classified by industry verticals from which skills are selected and to which specific attributes are added and defined in the skills attributes input forms. The flexibility of the skills-set libraries is driven by attribute selections, which can be added, modified, and deleted. The skills-set libraries contain skill descriptions and keyword-related terms for intelligent search purposes. The skills-set libraries are based on standards and include the latest skills based on today's technologies. Its organizational structure is extensive and includes intelligent relations between categories, sub-categories, and the skills itself.

Skills Management is the process of identifying, developing, and managing human/intellectual assets to optimize the capability and competitiveness of an organization. DigitalReach Skills Library is an inventory of standardized knowledge, skills, and other attributes used by employers, employees, and applicants for a precise Human Capital Management solution. Features of digitalReach Skills Library are:

1. A common platform among different Industry sectors

2. A configurable structure to meet specific business needs

The DigitalReach application allows users to select from a variety of set skills, and business functions that will eventually result in unparalleled skill-assessment standardization and a more quantitative and qualitative selection and employee development and retention processes. In order to provide users with a complete skills set or “Skills Library”, the newest information under each category are verified and added/deleted as needed. If the user cannot find a skill or function in the library, the user is given the option to add the skill.

When adding skills to a posting (3) or job request, the organizational unit manager (structure (11)) is given the options to calculate how many hands-on months and the skill level for each specific skill that is requested. They can also decide if the skill is required or desired for the job request. On the profile side, the candidate can also reveal how many hands-on months they possess as well as self-ranking themselves based on a defined 1 through 5 level system.

Design

Skills Library Overview

The overall layout of Skills Library is as follows and is configurable to support various industry sectors:

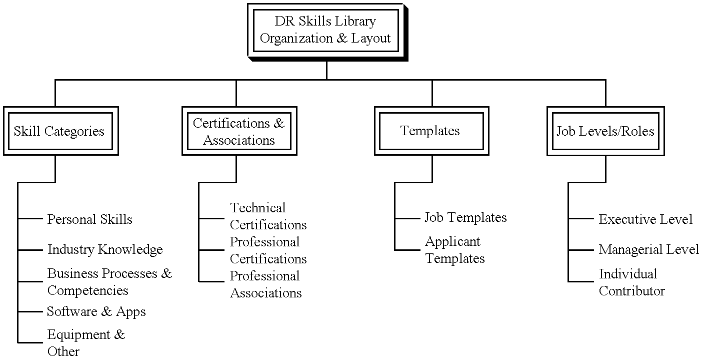

Skills Categories

All skills are divided into 5 major categories. Specific skills are organized in hierarchies. The Categories are described as follows:

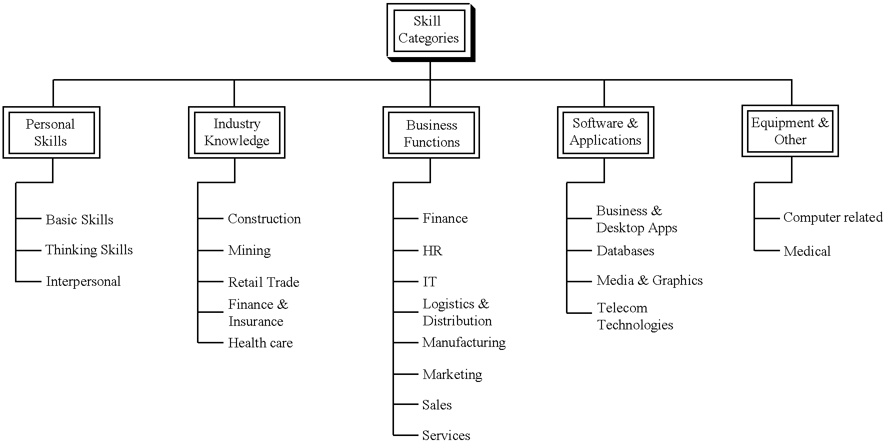

Personal Skills and Languages:

These are skills and languages pertaining to the given individual that were primarily acquired through education or experience at a personal level. The Personal Skills category contains skills that most people have used at some time in their lives but the level of expertise may differ. Each skill has a separate level definition attached to it so the user can easily decide what his or her level is. Every personal skill can be noted in all different industries.

1. Personal Skills:

The personal skills list is made up of four categories including basic skills, thinking skills, interpersonal skills, and supervisory and management skills.

2. Basic Skill:

The basic skills category will combine reading, writing, arithmetic and mathematical operations, listening, and speaking.

3. Thinking Skill:

The thinking skills category will combine skills involving creative thinking, decision-making, problem solving, visualization, learning abilities, and reasoning abilities.

4. Interpersonal Skills:

The interpersonal skills category will combine leadership, mentoring, diplomacy, negotiation and teamwork.

5. Supervisory/Management Skills:

The supervisory/management skills category will combine skills including management of personal resources, implementation planning, management of financial resources, management of material resources, time management, management issues and briefing skills.

Languages:

The ten different languages will be moved into the personal skills category with specific links to reading, writing, and speaking. The user will choose a defined level for each one. The ten different languages include, English, Chinese, German, French, Spanish, Italian, Dutch, Japanese, Russian, and Portuguese.

Industry Knowledge:

In this category, the user will find a list compiled of various departmental occupations that employs labor in a distinct branch of trade. Each Industry will drill down to a more exact knowledge where the user can rank his or her level and experience. The goal here is to represent every possible industry so that a user who has experience in multiple industries will find it easy to navigate and enter information. For Example: Manufacturing consists of Food, Chemical, Nonmetallic Mineral Product, Primary Metal Manufacturing, etc.

Business Functions/Processes:

This category is comprised of the key functions and processes implemented within a corporation. Corporations in most industries employ within these occupation functions. For Example: Finance, Human Resources, Information Technology, Logistics & Distribution, Manufacturing/Operations, Marketing, Sales, Services/Corporate Services.

These functions are further divided up into specific activities that are common to every industry.

Software & Applications:

This category is comprised of the latest technologies available. This category is especially configurable to allow users within a particular industry sector that has a very specific set of technologies that is used in their specialty. The user will choose his or her particular focus or concern and the section will drill down into a list of software and business applications that are used today. For Example: Telecommunication Technologies, Databases, Business and Desktop Applications, etc.

Equipment & Other:

Like the Software and Applications Category, the Equipment and Other category is comprised of the equipment used in various occupations. This category is especially configurable to allow users within a particular industry sector that has a very specific set of equipment that is used in their specialty. For example: Computer-related Equipment, Medical Equipment, etc.

Certifications and Associations

Certifications offered by various vendors, associations or institutes are listed in this section. It provides the user with the ability to validate any training he or she may have. The section consists of the actual certification name, the vendor, and a website or information site that the user can click on to find out more regarding the specific certification. All Certifications and Association lists can be configured into hierarchies that target specific specialties or industries. Certifications and Associations are divided in the following categories:

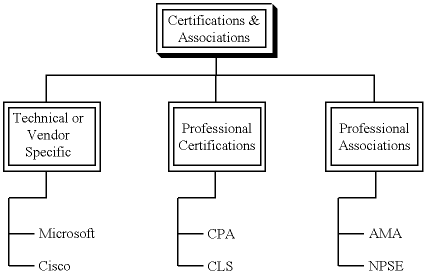

Technical or Vendor-Specific Certifications:

These are certifications offered by a particular vendor and usually relate to the products or services offered by them. Where the company name is listed, the user can link to the website where information regarding the certification and how to obtain one is available. For Example: Microsoft www.microsoft.com/ms.htm, Microsoft Certified Systems Engineer (MCSE), Microsoft Certified Professional, etc.

Professional Certifications:

These are certifications offered by different institutes and usually relate to specific professions. For Example: Certified Public Accountant (CPA), Certified Public Secretary (CPS), etc.

Professional Associations:

Professional Associations enable users to link themselves to a formal organization of people. It also provides a connection for employers and potential candidates. The correct association or organization name is provided along with the website so the user can find more information about any particular group. All industries are represented. For Example: National Human Resources Association, www.humanresources.org, National Society of Professional Engineers, www.nspe.org, Public Relations Society of America, www.prsa.org

Templates

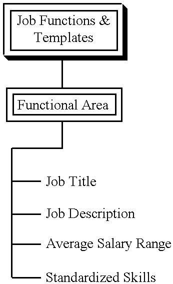

Job Templates:

Job Templates are created for generic job positions to develop a model or standard to make the job request process easier. The template will consist of a brief job description, a salary range, and a listing of standard skills that are commonly seen attached to the specific job posting. The template information represents averages at the time of hire and excludes other factors that may be part of a compensation package. We are assuming a candidate is working in a specific functional area on a full-time bases (40 hours per week) and may vary based upon market demand, company size, industry and geographic region. Currently, a list of jobs has been developed that is divided up into several categories.

For Example, one category might be “IT Help Desk”. This is then broken up into actual job titles including: Help Desk Manager, Help Desk Analyst, Help Desk Specialist, Help Desk Systems Administrator/Programmer, Technical Writer

Applicant Templates:

Applicant templates are created to make the application (profile posting) process easier. The template will include information that will allow an applicant to complete his or her profile to a specific skill set. Applicant templates allow users to target their experience to a specific job posting. For example, an applicant for a Regional Sales Manager will be provided with a template that contains the specific skills specific to her position. She would then enter her relevant experience to these skills and may add any additional skills she may feel are appropriate. This would reduce the time that she would spend looking for a lot of the Sales Manager specific skills. The following is an example of the Technical Writer Template: Technical Writer, Template ID #1, Job Description.

Job Levels

Job levels are primarily used for matching purposes. In order to match applicants with jobs at their desired levels of experience, job levels are important. For example, an executive may have some of the skills used by an individual contributor but may not be interested in being notified about jobs at that level. Job levels can be configured easily to fit the organization chart of a company. Generic Job levels currently defined are as follows:

1. Executive Level (Positions at the director level and above)

2. Managerial Level (Managerial positions including Supervisors, Team Leads, Shift managers, etc)

3. Individual Contributors (Positions such as specialists, analysts, coordinators etc)

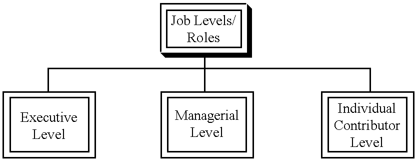

Skill/Proficiency Levels

The application uses the numbers 1-5 to describe an applicant's skill level in regards to a specific skill. For Personal Skills, Software Applications, Business Functions, Equipment, and Industry Knowledge, the skill levels will all be defined as follows:

1. Level 1—Minimal or some experience, works with supervision. Ability to identify and determine a problem at a personal level.

2. Level 2—Ability to identify and produce a solution to a problem with some personal experience.

3. Level 3—Works independently or without supervision in most cases. Ability to identify, evaluate and produce a solution to a problem with minimal professional experience and some supervision.

4. Level 4—Ability to independently identify, evaluate, and develop an action plan to produce a solution to a problem at an advanced level with some professional experience and minimal supervision.

5. Level 5—Senior/Supervisory or teaching level. Ability to independently identify, evaluate and determine the better action plan to produce a solution to a problem at the expert level with noted professional experience.

Use Case

Skills Search Engine

When accessing the Skills Tree, whether in a Candidate Profile or a Job Request, the Skills search engine is used to reduce the amount of time it takes to locate a specific skill. A Search function of the skills tree could drill down more quickly and bring back a more accurate result. Following are the example of steps to use Skills Search Engine:

1. Access application

2. Access a Candidate Profile or Job Request (new or established)

3. If the record is new, a name is assigned.

4. At the display screen, if the record is new, complete each required section as needed. When the section Skill Set Summary appears, click on the EDIT button.

5. At the EDIT SKILLS screen the search functionality will be housed at the top of the screen.

The tree window that is located within the edit screen will act as a result window when in search mode. Above the tree will be a display option function.

1. To locate a specific skill, the user will select a display option, then use either the search keyword OR search phrase edit box, click OK.

2. The result will display in the tree window. The result should include all branches as well as the specific result.

3. The selection box is also present. When this is checked, the detail information needed for that skill could be added and saved. Based on the category where the skill was located on the tree, it will populate the appropriate section of the right side of the window.

4. In the event that multiple results display the screen has the ability for the user to select more than one and populate in the edit section on the right hand side to have the detail information entered.

a. If the skill is not found in one option, another display option can be used.

b. If no results are found, an error window appears indicating that the search item could not be found and directing the user to check their request or try a different search.

Skills Emphasis/Focus Areas

The Chart below shows what areas of the digitalReach Skills Model a user should focus on depending on the type of position one is interested in. This is a generic guide and does not address any specific occupation. Quantitative factors such as Hands on Experience and Skill Proficiency Levels also define the type of experience an applicant may have or a hiring manager may be looking for.

[chemical structure]

Entry Level:

Due to lack of actual work experience of entry-level applicants, job requests for entry-level positions are usually based on Personal Skills and Educational background. When filling out a Job Request, a hiring manager seeking to fill an entry-level position for should place emphasis on Personal Skills.

Junior-Mid Level (Subject Matter Expert):

Junior-Mid level individuals develop transferable skills within Business Functions and Software and Applications used. Emphasis must be placed on specific business functions, Software and applications used and Equipment if necessary. For example, a Financial Analyst position may require hands on experience in Financial Reporting/Analysis, Cost Accounting and knowledge of Oracle Financials. Important questions to ask when filling out a Job Request at the managerial level are:

1. What specific Business Functions are required for this position?

2. What tools (Software and Applications) are required for this position?

Senior Individual Contributors—Managerial Level:

Working relationships (working with other Business Functions and/or Industries), processes, and Personal Skills are most important in managerial positions. A Product Marketing Manager, for example, is required to have a strong background in Product Marketing, Market Research and Analysis and should also have working knowledge of the Manufacturing/Product Development processes. Important questions to ask when filling out a Job Request at the managerial level are:

1. What core Business Functions required for this position?

2. What other Business Functions outside his specialty must the candidate have knowledge of?

3. What Industry Knowledge/Background is required?

4. Is knowledge of other industries required for this position?

Senior Managerial—Executive Level:

Most emphasis is placed on knowledge of all subcategories within a Business Function, working relationships, and industry knowledge. For example, a Sales Executive must have knowledge of all Sales functions, an excellent background of the industry he/she is employed in and the industry he/she will be selling to. This applies as follows: A VP of Sales in a Software company that specializes in Health Care software has excellent backgrounds in both the Software and Health Care Industries. Key questions to ask when filling out a Job Request for a position at the executive level are:

1. What Business Functions required for this position . . . all major subcategories within the Business Function?

2. What other Business Functions outside his/her specialty must the candidate have knowledge of?

3. What Industry Knowledge/Background is required?

4. Is knowledge of other industries required for this position?

5. What are some corporate objectives that need to be met? This information can be input in the assignment description area

Some Examples:

Below are examples of Job requests that have been extracted from job boards. In order to convert these to DRC Job Requests, the thought process described above has been applied and some specific skills have been listed:

Entry Level:

Entry-level Project Manager (Marketing and Advertising):

We are currently looking for entry-level Project Manager that is interested in learning every aspect of the business. This would include marketing, advertising, sales, promotions and public relations. We work with the most innovative, exciting companies in the market today. Full paid training is provided. The opening is ideal for recent graduates or professionals seeking a career change. If you are ready to get started or looking for a change, contact us.

REQUIREMENTS:

Ambitious, Hard working, Team player, Willingness to learn, An eye for future growth.

Conversion to a DRC Job Request:

| DRC Skill Category | Skills |
|---|---|
| Personal Skills | Teamwork |
| | Learning Skills |

Junior-Mid Level Positions (SMEs): Financial Analyst

Primary Responsibilities

1. Function as a primary resource on various account-related initiatives/projects.

2. Provide functional support for general ledger related issues.

3. Provide support for month-end close processes needed.

4. Assist in the process of streamlining and documenting departmental processes and procedures.

Job Qualifications

1. Bachelor's degree in Finance or Accounting.

2. Experience with Oracle General Ledger and Oracle Financial Analyzer.

3. Experience with a company having complex, multiple operations and/or multiple locations.

4. Communications skills, both interpersonal and in written form, must be excellent.

5. Independent worker with high level of energy.

Conversion to DRC Profile:

| DRC Skill Category | Skills |
|---|---|
| Personal Skills | Communication, Writing |
| Business Functions | Finance/Accounting |
| Software & Applications | ERP Packages - Oracle GL, |
| | Oracle Financials |

Senior—Managerial Level:

Manager, Incentive Compensation—Development and implementation of incentive compensation plans and administration of bonus and stock related programs.

Specific Responsibilities:

1. Design, implement, and maintain incentive compensation plans for business-to-business, retail, and other direct sales, customer service, and corporate management—both bonus and commission based plans.

2. Meet with top management to understand business strategy as it relates to incentive pay.

3. Work with management to design plans that align with and support business strategy.

4. Conduct total compensation competitive analysis to determine appropriate compensation levels and design features, mix, etc.

5 . Interface with commission system and Information Technology personnel to ensure that plan designs are feasible for implementation.

Administer corporate bonus and stock related programs, including executive programs.

Qualifications:

1 . Bachelor's degree in related discipline or equivalent experience; Masters degree a plus.

2. 5-8 years experience in the design and administration of incentive compensation programs; emphasis on design.

3. 1-2 years experience in executive compensation administration preferred.

4. Strong computer skills, including facility in spreadsheet analysis.

5. Strong written and verbal communication skills

| DRC Skill Category | Skills |
|---|---|
| Personal Skills | Writing, Communication, |
| | Implementation Planning |
| Business Functions | Human Resources, IT, Sales |
| Industry Knowledge | Retail Trade |
| Software & Applications | Microsoft Office (Excel) |

Senior Manager—Executive Level:

Practice Manager:

You will be responsible for building your practice from the ground up. You will have Budget and Forecast Responsibility, Recruiting, Mentoring, Managing consultants, and Client Development Experience in Telecom and/or Utilities Industry, a Consulting Environment, Budgeting, Forecasting, and Business Development. The individual should also have technical knowledge of Oracle, SQL, E-Commerce, UNIX, and Windows NT, along with solid communication and presentation skills. Eight or more years as a professional in a Management or Sales discipline and a willingness to travel are required. Technical Bachelor's degree and prior consulting experience are preferred

| DRC Skill Category | Skills |
|---|---|
| Personal Skills | Mentoring, Communication, Management of |
| | Personal Resources, Management of |
| | Financial Resources, Briefing Skills |
| Industry Knowledge | Telecommunications, Utilities, Software |
| Business Functions | Sales, Marketing, Corporate Services, |
| | Finance/Accounting |
| Software and Applications | Oracle, SQL, E-Commerce, Unix, Windows |

dR Forms

Description

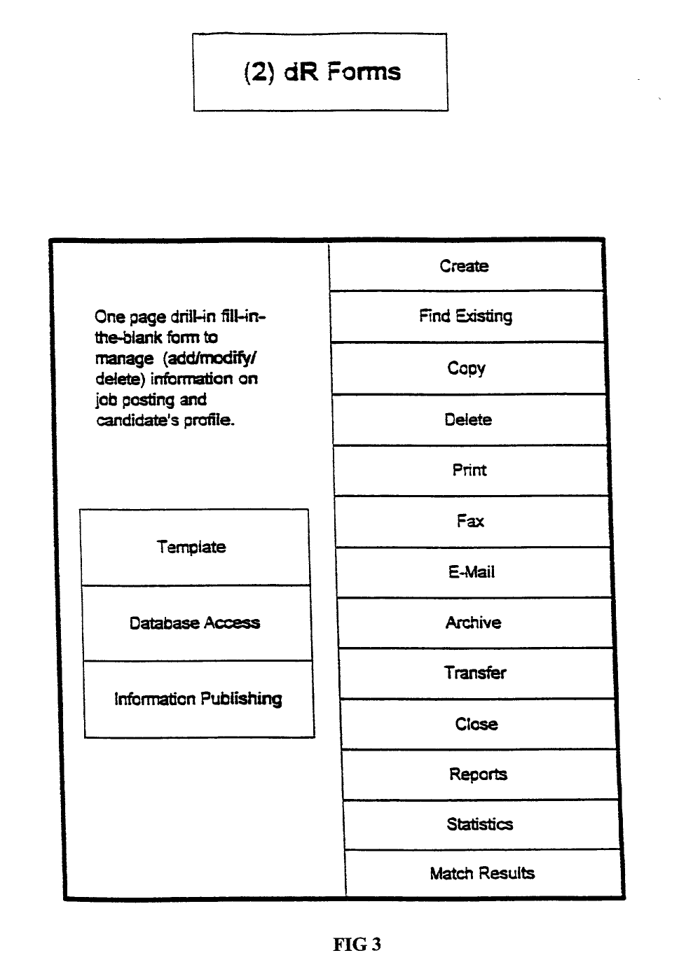

Now referring to FIG. 3, the invention can provide an environment for job posting and candidate profile administration. Specifically, this invention provides a single page drill-in form interface where the system functions are controlled (such as create, edit, copy, find existing, templates, print, delete, e-mail, fax, post, archive, transfer, close, reports, statistics, and matching results). This also provides a template for data entry assuring consistency and more extensive information content. The one page fill-in-the-blank like form interface provides an easy way to enter the information and see instant results about the progress at every step. This invention also provides the user access to all functions from a single click.

In order to provide users with a familiar and convenient way to manage their activities, we will have an Activity Hub. After the users log-on credentials are verified, the Activity Hub screen is displayed. This screen serves as a home page where users can originate all the different activities they are allowed to access. When the page opens, it will have a menu bar at the top of the screen and a summary view of request data below. The menu bar will allow users to navigate through common tasks.

Design/Use Case

Appearance

1. After the user's log-on credentials are authenticated, the Activity Hub is displayed.

2. There is a row of menu items at the top of the screen. Each menu item will display a drop down list of related tasks when the user points to the item.

3. Although the complete set of menu options are described in this document, only those items are displayed that the logged-on user has access to perform. Additionally, when a user selects an item, options in the list that the user has access to perform but do not apply based on the current screen, appears grayed out.

4. The complete set of menu items includes: File, Edit, Preferences, View, Tools, Administration, Help.

File

1. The “File” menu item displays a list of common tasks relevant to Job Requests and Personal Profiles.

2. There is a “New/Create” option with sub-items of “Request” and “Profile”. This will only be visible to users who have access to create either new Requests or new Profiles or both.

3. There is an “Open” option with sub-items of “Job Request” and “Profile”. These allow users to edit existing documents by picking from a list of names of existing document that they have access to view.

4. There is also a sub-item under “Open” for “EEO Information”. Selecting this option takes users to the screen where they can review and/or update their own EEO data.

5. There is a “Print” option. This option opens a new window with a printable formatted version of the screen's contents displayed.

6. There is a “Save as/Copy” option. This option is accessible from a Job Request or Profile and allows the user to save the selected document under a new name so as to make a copy of it.

7. There is a “Send” option with sub-items of “E-Mail” and “Fax”. This option gives the user a way to e-mail or fax the request or profile they are viewing, directly from our application.

8. There is a “Log-off” option which will log-off the user and return them to the Home/Log-In screen.

Edit

1. The “Edit” menu item displays a list of copying and editing activities that apply to the current selection.

2. There are options for “Cut”, “Copy”, and “Paste” that allow the user to manipulate and move selections of text.

3. There is a “Rename” option that changes the name of the profile or request the user is currently viewing.

4. There is a “Delete” option that permanently deletes the request or profile the user is currently viewing. Not all users have access to this option.

View

1. The “Vi” menu item displays items that allow the user to change the view on the Activity Hub.

2. There are options of “Job Requests”, “Employee Summary”, and “Personal Profiles”.

3. The default view is the Personal Profiles view.

4. Under the View menu item, there is an option for Reports.

5. Under the View menu item, there is an option for “Last Match List”. When selected this presents a view of the last system generated match list for that request or profile.

Tools

1. The “Tools” menu item displays items that enable users to perform specific functions like the search feature available on the Master Search Page.

2. There is an option for “Match Now” that runs the match engine for the current document and provides the user with a new, current match list.

3. There is an option for “Search” with sub-items of “Requests” and “Profiles”. When a user selects one of these options they are presented with the master search page and are allowed to enter criteria to specify a desired results set.

4. There is an option for “Password Maintenance” that allows users to change their existing password by entering the current password and then indicating a new one.

5. There is an option for “Personal Preferences” with sub-items of “Privacy and Notification” and “View”.

7. When users select the Privacy and Notification option, they will be presented with a list of questions regarding whether or not the following information should be presented to other users regarding the current (the one they are currently viewing) profile/request: name, phone, e-mail, URL, Address, Fax, Contact and the desired frequency for e-mail notification.

8. To specify the e-mail frequency, the user will have a set list of choices: every 1, 3, 8, 24 or every 156 hours (once a week).

9. Users will be able to specify the maximum number of results per match per profile: This refers to number of matches per request or per profile. All existing matches will be sent in each email (up to a maximum specified). Profiles that have been submitted in a previous e-mail will be flagged.

10. There will also be a “View” option that allows the user to indicate which summary view is the desired default.

Administration

1. The “Administration” menu item display options pertaining to the system set-up and maintenance.

2. Following items under Administration: “Role”, “User”, “Organizational Unit”, “Transfer”, and “System Tools”.

3. Access to these items is based on the role access for that user.

4. The “Role” item has sub-items for: “General” and “Setup Tables”. Selecting one of these options will take the user to one of the Role set-up screens.

5. The “User” item will take authorized users to the user maintenance pages.

6. The “Organizational Unit” item will take the user to the OU set-up screen.

7. The “Transfer” item will take the user to a screen that allows a manager to transfer one of his/her employees to a new department.

8. The “System Tools” option will have items for, “EEO Disclaimer”, and “Setup Tables”.

Help

1. The “Help” menu item provides the user with help for the particular screen he/she is on and provides them with a search option to find help on other screens.

2. When the Help option is selected, a new browser window will be opened.

dR Posting

Description

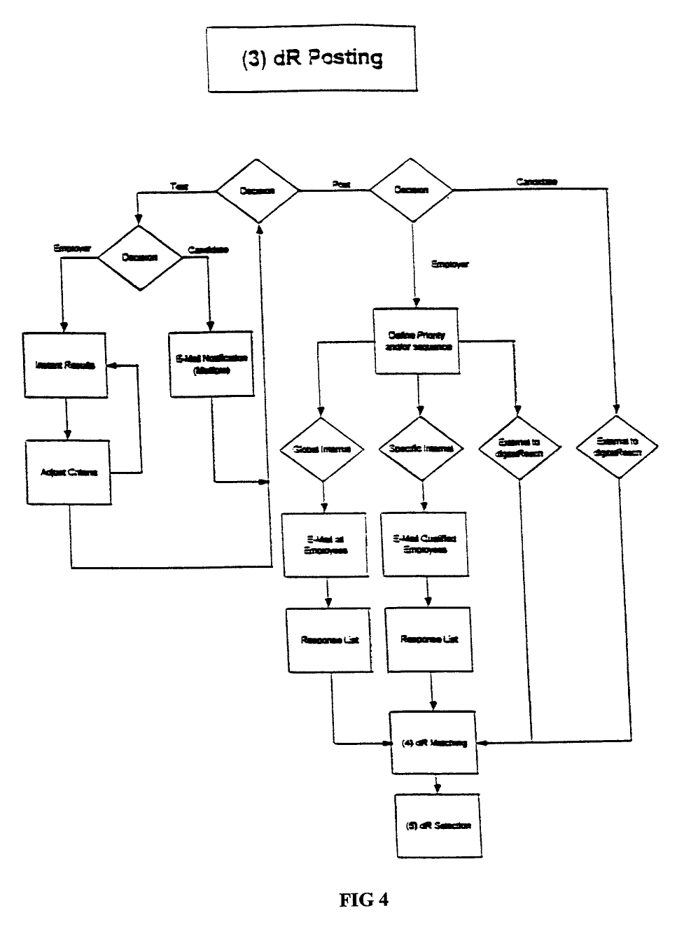

Now referring to FIG. 4, the invention can enable involved parties (employers and candidates) to activate and/or test their job posting or candidate profile. Specifically, this invention provides a testing function that allows employers to receive instant feedback and adjust their criteria in real time to get a feel of matching results, and allows candidate to browse matched open position with no further obligations. The activation function initiates the matching process for all involved parties (employers and candidates) and from that point that information is available to all applicable parties. This invention also provides employer different posting options such as posting to all employees, internal qualified candidates, and externally to digitalReach main candidates database. The employer can also prioritize and/or choose the sequence of multi-posting. One set of features in the digitalReach suite of products involves the Communication and “Broadcasting” of data outside of the application.

Design/Use Case

E-Mailing

1. Users can e-mail a job request or candidate profile directly from the administrative center.

2. There is a Menu item for “Send E-Mail” under “Manage” on the menu bar.

3. When users select this option they are prompted to complete the destination information and the request/profile will be sent.

4. The user will need to enter the Recipient's name, address, and a subject line.

5. The content and lay-out of the data will be the same as it is when a user selects the print option.

Faxing

1. Users can fax a job request or candidate profile directly from the administrative center provided that the client has a pre-established account with eFax.

2. There is a Menu item for “Send Fax” under “Manage” on the menu bar.

3. When users select this option they will be prompted to complete the destination information and the request/profile will be sent.

4. The user will need to enter the Recipient's name, fax number, and a subject line.

5. The content and lay-out of the data are same as it is when a user selects the print option, except that there will be a cover page that will list the recipient's name, fax number, text from the subject field and the sender's information based on the selected profile or request. These specifications are based on the limitations of efax and may at some point be enhanced.

Privacy and Sending

1. When sending an e-mail and/or fax from the application, there are special rules for privacy preferences.

2. If users are sending their own profile or job request, identity information is not hidden. Therefore, a warning will be issued before sending the information and required a confirmation.

3. The warning has the following verbiage: In the privacy preferences for the profile/request that you are about to send, you have indicated that you wish to keep some of your identifying information private. This information will not be hidden when you send via e-mail/fax. Do you still wish to continue?” and will offer two buttons, “Continue” and “Cancel”.

4. If users are sending a profile that is not their own (for example, a manager who wants to share a candidate they received via a match list with someone who does not have access), whatever privacy is in effect when they view the data will also be in effect when they send the data.

Broadcasting

1 . The Broadcasting functionality is expanded to allow users to “broadcast” Job Requests to preferred external job boards and their web sites.

2. Other Broadcasting options are added such as newspaper ads, etc.

dR Matching

Description

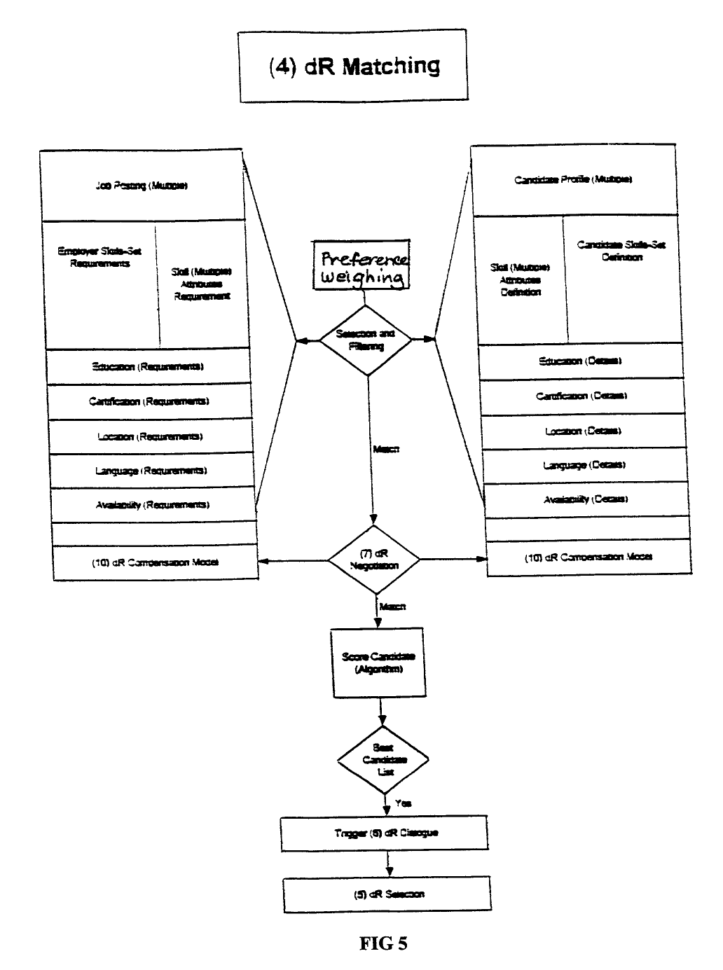

Now referring to FIG. 5, the invention can provide a selection and filtering process for precision matching that uses the skills-set libraries (1) for accuracy. Specifically, this matching process provides precision and consistency by using pre-defined set (1) requirements for skills, logistics, compensation (7,11), and match preferences (8). The matching process scores qualified candidates based on their own skills-set attributes and provided information such as education, certifications, compensation expectation, location, language, and availability. This invention provides the employers a detailed list of the best candidates based on their requested criteria. This invention also triggers the dialogue (6) between involved parties (employers and candidates) providing the basis for communication to exchange information without having to retrieve contact information. The digitalReach matching engine matches and scores Candidates to jobs, and jobs to Candidates. The matching engine algorithm involves a two-step process. The first step is Filtering. The second step is Scoring.

Matching Candidates to Job Requests:

Filtering involves paring the existing Candidate pool down to a sub-set that matches or exceeds the Job Request's specified requirements. Scoring involves ranking the remaining Candidates based on how well their skills, education and certifications match those asked for in the Job Request.

Matching Job Requests to Candidates:

Filtering involves paring the existing Job Request pool down to a sub-set that matches the Candidate's Individual Profile. Scoring involves ranking the remaining Job Requests based on how well their requested skills, education and certifications match those specified in the Candidate's Individual Profile.

Matching Engine Customization:

The Matching Engine is customizable to fit any businesses unique environment. As such, a variety of parameters are available. These parameters are grouped into three categories: Filtering Parameters, Scoring Calculation Parameters, and User Importance Ranking Parameters.

Filtering Parameters allow the customer to adjust the filtering algorithm to fit the customer's environment. The Filtering Parameters include: Position Level, Location, Availability/Start Date, Travel, Required Certifications, Required Education, Compensation, Required Skills.

Scoring Calculations Parameters are used to adjust the way the scoring algorithms rank Candidates/Job Requests. Changing these parameters changes how points are awarded when the matching engine runs. The Scoring Calculation Parameters include: Excess Skill Experience Cap, Excess Skill Experience Score, Excess Skill Level Score, Current Skill Score, Excess Education Score, Non-Current Skill Score, Desired Skills Score, Desired Certifications Score.

User Importance Ranking Parameters allow the Customer to rank the scoring items with respect to each other. This allows the businesses to designate which scoring items are more/less important, relative to the other items. For example, if Skill Experience is assigned a higher weight than Education, which means the customer is more interested in the Candidate's experience than the Candidate's degree. The User Importance Ranking Parameters include: Hands On Experience Importance, Skill Level Expertise Importance, Current/Non-Current Importance, Certification Importance, Education Importance.

Design

Filtering Parameters

Filtering takes place before scoring. The goal of the filtering process is to reduce the entire Candidate/Job Request pool down to a smaller group, which can then be scored.

1. Individual Profile Status. Both the Individual Profile Status and the Job Request Status must be green (active) or yellow (test) for a match to occur.

2. Position Level (Executive, Management or Individual Contributor). The Individual Profile can have up to two desired Position Levels specified. The Job Request has one Position Level specified. At least one of the Individual Profile's Position Levels must match the Job Request's Position Level.

3. Specified Location. The Individual Profile can have a number of Desired Locations specified. The Job Request has one Work Location. At least one of the Individual Profile's Desired Locations must match the Job Request's Work Location, or the Individual Profile's Available to Relocate field must be set to Yes.

4. Candidate Availability. The Individual Profile's Availability Date is less than or equal to the Job Request's Latest Start Date.

a. An Availability Parameter can be set to allow for some flexibility in this calculation. For example, if the Availability Parameter is set to 1 week and the Job Request Latest Start Date is set to Jan. 1, 2001, then any Candidate with an Individual Profile Availability Date of Jan. 8, 2001 or less will be allowed through the filter.

5. Travel Requirements. The Individual Profile's Maximum Travel Percentage must be greater than or equal to the Job Request's Maximum Travel Percentage.

a. The businesses can set a Travel Parameter to allow for some flexibility in this calculation. For example, if the businesses sets the Travel Parameter to 10% and the Job Request Maximum Travel Percentage field is set to 40%, then any Candidate with an Individual Profile Maximum Travel Percentage of 30% or greater will be allowed through the filter.

6. Required Certifications. The Job Request may have one or more listed certifications designated as Required. If a certification is Required on the Job Request, the certification must be present on the Individual Profile.

a. If the Candidate does not have the Required Certifications specified in the Job Request, they will not pass through the filtering process and they will not be scored.

7. Required Education. The Job Request may have a level of education designated as Required. If education is Required on the Job Request, the specified education, or a higher level of education, must be present on the Individual Profile.

a. If the Candidate does not have the Required Education specified in the Job Request, they will not pass through the filtering process and they will not be scored.

8. Compensation. The Job Request has a Maximum Annual Compensation field. The Individual Profile has a Desired Annual Compensation field. The Individual Profile's Desired Annual Compensation must be less than or equal to the Job Request's Maximum Annual Compensation.

a. The customer can set a Compensation Parameter to allow for some flexibility in this calculation. For example, if the customer sets the Compensation Parameter to 10% and the Job Request Maximum Annual Compensation field is set to $50,000, then any Candidate with an Individual Profile Desired Annual Compensation of $55,000 or less will be allowed through the filter.

9. Required Skills. The Job Request may have one or more listed skills designated as Required. If a skill is Required on the Job Request, the skill must be present on the Individual Profile.

a. The customer can set a Required Skill Experience Parameter to allow for some flexibility in this calculation. For example, if the customer sets the Required Skill Experience Parameter to 80% and the Job Request Required Skill Experience field is set to 100 months, then any Candidate with an Individual Profile Skill Experience of 80 months or greater will be allowed through the filter.

b. If the Candidate does not have the Required Skills specified in the Job Request, they will not pass through the filtering process and they will not be scored.

| Individual Profile | Database Table & | Job Request Matching | Database Table & Variable |
|---|---|---|---|
| Matching Engine Inputs | Variable Name | Engine Inputs | Name |
| Individual Profile Status | Candidate Profile | Job Request Status | Job Request |
| Green | Profile_Status_Code | Green | Request_Status_Cd |
| Yellow | | Yellow | |
| Red | | Red | |
| Desired Position | Candidate Position | Position Level | Job Request |
| Desired Position 2 | Position_Name | Executive | Position_Level |
| Executive | | Manager | |
| Management | | Line Manager | |
| Individual | | Individual | |
| Contributor | | Contributor | |
| (Entry Level?) | | (Entry Level?) | |
| Desired Work Locations | Desired Location | Assignment Location | Job Work Location |
| Desired Location 1 | Country_Cd | City | Country_Cd |
| (City) | Region_Cd | | Region_Cd |
| Desired Location 2 | City_Cd | | Job_Work_Location_Id |
| (City) | Desired_Location_Cd | | |
| Desired Location 3 | Candidate Profile | | |
| (City) | Relocate_Flag | | |
| Desired Location x | | | |
| (City) | | | |
| Available to Relocate | | | |
| Available Start Date | Candidate Profile | Target Dates | Job Request |
| | | Latest | Latest_Start_Dt |
| | Employment_Avail_Dt | | |
| Willing to Travel | Candidate Profile | Max Travel | Job Request |
| | Max_Travel_Percentage | | Max_Travel_Percentage |
| | | | Min_Travel_Percentage |
| Certifications | Candidate Certification | Certifications | Job Certification |
| Professional | Certification_Name | Required (Y/N) | Required_Flag |
| Associations | | | Certification_Name |
| Professional | | | |
| Certifications | | | |
| Technical | | | |
| Certifications | | | |
| Diploma/Degree | Candidate Education | Diploma/Degree | Job Education |
| | Degree_Type_Name | Required (Y/N) | Required_Flag |
| | | | Degree_Type_Name |
| Desired Compensation | Candidate Profile | Compensation | Job Request |
| | Total_Compensation | Minimum | Total_Compensation_Max |
| | | Maximum | |
| Skills | Candidate Skill | Required Skills | Job Skill |
| Hands On | Hands_On_Months | Hands On | Required_Skill_Flag |
| Skill Level | Skill_Level | Skill Level | Hands_On_Months |
| Skill Status | Current_Flag | Skill Status | Skill_Level |
| (Current/Non- | | (Current/Non | Current_Flag |
| Current) | | -Current) | |
| | | Desired Skills | |
| | | Hands On | |
| | | Skill Level | |
| | | Skill Status | |
| | | (Current/Non | |
| | | -Current) | |

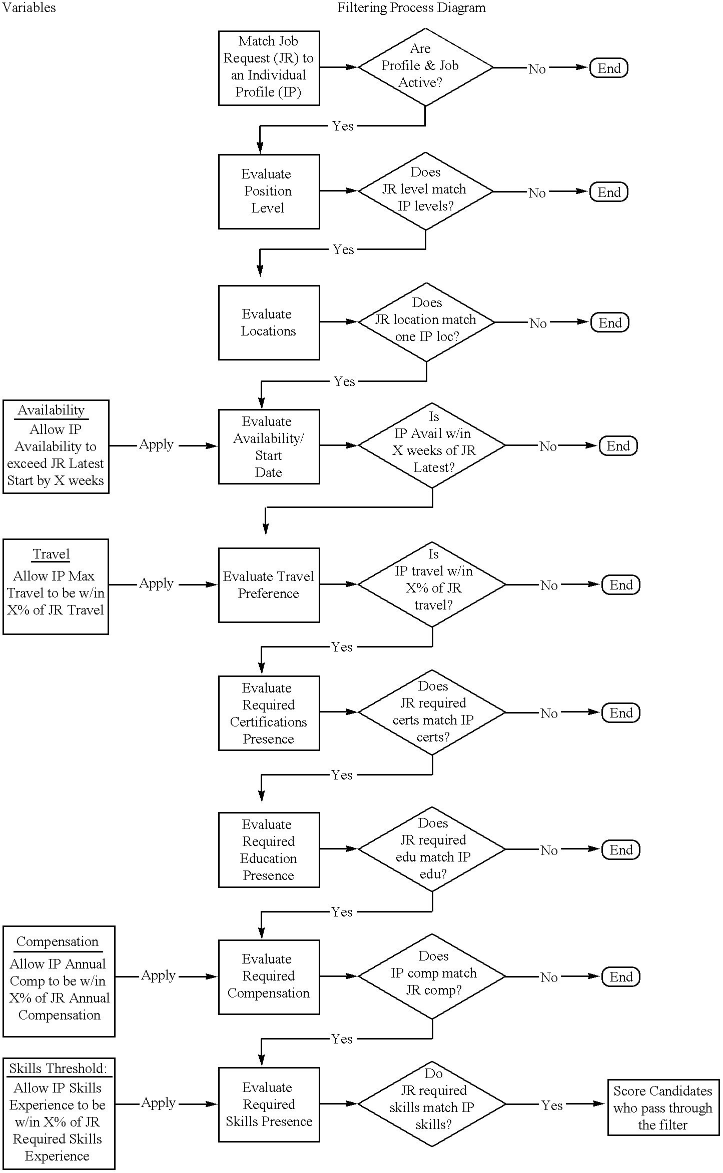

Scoring Calculations Parameters

Scoring is based on the following items:

1. Required and Desired Hands On Skill Experience. Job requests define both a set of required skills as well as a set of desired skills that represent the requestor's needs. For each skill, both required and desired, the job request also defines an experience level in months. The Candidate profile lists the candidate skills and number of months experience at each skill. The scoring algorithm generates a numeric value representing the degree of experience match for each candidate considered against a specific job request.

2. Required and Desired Skill Level. For each skill defined in the job request, both required and desired skills, the job request defines an experience level from 1 to 5 where a lower value represents less experience. The candidate profile lists the candidates skill level for each candidate skill. The scoring algorithm generates a numeric value representing the degree of skill level match for each candidate considered against a specific job request.

3. Required and Desired Skill Currency. For each skill defined in the Hob Request, both required and desired skills, the job request defines whether the skill must be current or not. The candidate profile lists the candidate's currency at each skill. The scoring algorithm generates a numeric value representing the degree of skill level match for each candidate considered against a specific job request.

4. Desired Education. The Job request defines the required education level for the requested position. If a candidate exceeds the required education level, additional scoring credit may be. The Job request may define a required education level and a desire for a higher level. If a candidates education level on the candidate profile exceeds the job request's required level and the job request also desires a higher level, the scoring algorithm gives higher educated candidates higher scores. If the job request does not indicate a desired education, no additional scoring credit is given for education levels that exceed the job request required level

5. Desired Certifications. The Job request defines required certifications for the requested position. If a candidate has more certifications, additional scoring credit may be. The Job request may define a required set of certifications and desire additional certifications. If a candidate has additional certifications over and above what was required, and the job request also lists these certifications as desired, the scoring algorithm gives the candidate credit for the additional certifications. If the job request does not indicate desired certifications, no additional scoring credit is given for additional certifications.

Scoring Skill Experience

1. Skill Experience is scored using a Break Point Scoring System.

a. Full points are awarded for experience until the first Break Point is reached. Scoring Points are based upon the ratio of the candidate's experience divided by the requested experience.

b. Additional points are awarded at reduced rate for experience from the First Break Point to the Second Break Point.

c. No additional points are awarded after the Second Break Point is exceeded.

2. The customer can adjust the First and Second Break Points.

a. For experience only, the Second Break Point is a multiple of the First Break Point.

3. The customer can adjust the Excess Skill Experience Parameter to adjust the amount of points awarded between the First and Second Break Points.

Scoring Skill Level

1. Skill Level is scored using a Break Point Scoring System.

a. Full points are awarded for Skill Level until the first Break Point is reached.

b. Additional points are awarded at reduced rate for experience from the First Break Point to the Second Break Point.

c. No additional points are awarded after the Second Break Point is exceeded.

2. The customer can adjust the First and Second Break Points.

3. The customer can adjust the Excess Skill Level Parameter to adjust the amount of points awarded between the First and Second Break Points.

Scoring Skill Currency

1. Skill Currency scoring is accomplished by a straight award of points.

a. If the Candidate is current in the specific skill, they are awarded full points.

b. If the Candidate is not current in the specific skill, they are awarded partial points.

2. The customer can adjust the full points awarded amount.

3. The customer can adjust the partial points awarded amount.

Scoring Education

1. Education is scored based on the amount of education specified in the Job request.

2. The customer can adjust the amount of points awarded for Education.

Scoring Certifications

1. Certifications are scored based on the Certifications specified in the Job request.

2. Candidates with some or all of the Job Request's desired certifications (if any) will receive additional points.

3. The customer can adjust amount of points awarded for certifications.

Score Weighting

1. The customer can assign a weight to each of the items listed under above criteria.

2. The weight of an individual item scales the Candidates score with respect to each of the other items.

3. Weights can be adjusted from 0 (low) to 10 (high).

Activity Hub

1. On the Summary View page, for both Candidate Profiles and Job Requests, the Last Run Returned column displays a zero if no matches are found.

2. The Last Run Returned column always reflects the lesser of the total number of matches found or the “number of matches to be received” specified in the user's Preferences. The number is NOT be decremented by the number of matched items emailed to the user.

3. On the Match Summary page, for both Individual Profiles and Job Requests, a column is displayed for the Match Engine Scoring total. This column is labeled “Score”.

4. The Match Summary page contains a link to the appropriate Match Preview page from the Request ID or Profile ID column.

The Match Summary page contains a link to the Messaging page from the Messages column.

The Match Engine score is always be stored as an “nnn.nnn” value and displayed as “nnn.nnn%”.

The Match Preview page allow a clear comparison of the Job Request and Candidate Profile.

Email

1. Emails are sent to users regarding Match Engine results.

2. Emails are sent to the Creator ID of the Job Request and the Candidate ID of the Candidate Profile. Only sends emails if the Creator ID and Candidate ID are “not disabled”.

3. There is one email for each active Job Request or Candidate Profile being matched against. Emails are not sent for Jobs Requests or Candidate Profiles in inactive or test status. For example, if a manager has four active Job Requests she/he will receive four separate emails.

4. The email contains a link to the application Log-On page.

5. If there are no matches, an email is still sent indicating that no matches were found.

6. When there are matches, the email contains all the matches found up to the number of matches specified in the user's Preferences.

7. If scoring within the Match Engine results in a tie and the results would normally exceed the number of matches requested to be displayed by the user, all “tied” items are displayed.

8. The Match Engine email for employers contains the following verbiage, “You have requested to see the top X matches against your Job Request”, where X represents the value specified in the user's Preferences.

9. The Match Engine email for candidates contains the following verbiage, “You have requested to see the top X matches against your Candidate Profile”, where X represents the value specified in the user's Preferences.

10. The total number of matches is also contained in the email.

11. The Match Engine email subject line contains the Job Request Number and Job Request Name or the Candidate Profile Number and Candidate Name.

12. The email contains a list of matches, sorted from the highest score to the lowest with a secondary sort by candidate last name in case of a scoring tie, with the following information:

a. Score (nnn.nnn%), Candidate Name (Last, First), and Candidate Profile Number, OR

b. Score (nnn.nnn%), Contact Name (Last, First), and Job Request Number

13. The email indicates which items are new matches.

History

1. Match Engine results are captured in history tracking each time the Match Engine runs via the batch process.

2. When users query the application for matches the Match Engine results are NOT captured in history tracking.

3. Match Engine history captures the following fields: Match Result ID, Candidate ID, Candidate Profile ID, OU ID, Job Request ID, Total Score, and the update date/time. The history table also contains information on if an email has been sent to the Candidate or the Employer organization.

4. History captures any changes to existing matches by recording the deltas and then deleting all unchanged records. This allows the Job Request Summary of Personal Profiles Summary to reflect consistent values between executions of the Match Engine.

Use Case

Skill Experience Scoring Example

In the example below, X=skill experience (in months) from a Job Request. X is the First Break Point. 2X is the Second Break Point. Full points are awarded from Zero to the First Break

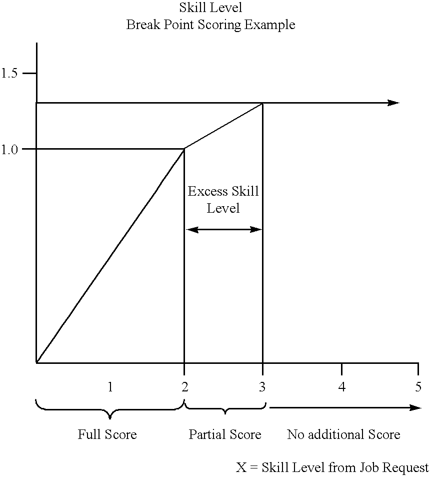

Point. Additional points are awarded from the First Break Point to the Second Break Point, but at the Excess Skill Experience rate (in this example it's 0.5). The customer can adjust the Break Points and the scoring factor for Excess Skill Experience (experience from the First Break Point to the Second Break Point).

In the example below, X=Skill Level (1-5) from a Job Request. X is the First Break Point. X+1 is the Second Break Point. Full points are awarded if the Candidate's Skill Level matches the Job Request Skill Level (First Break Point). Additional points are awarded from the First Break Point to the Second Break Point, but at the Excess Skill Level rate (in this example, it's set to 0.5). The customer can adjust the Break Points and the scoring factor for Excess Skill Level (experience from the First Break Point to the Second Break Point).

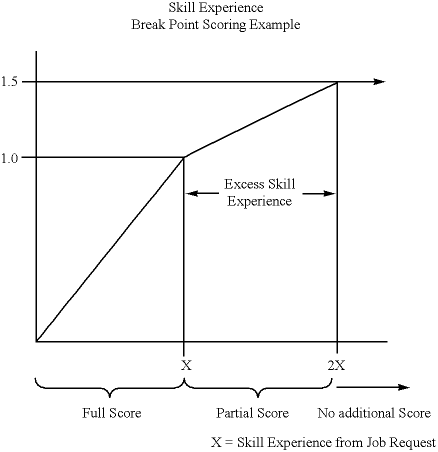

Candidate Scoring Math

$$Candidate Score = \frac{\begin{matrix}( Experience Score + Skill Level Score + \\ Currency Score + Education Score + \\ Certification Score )\end{matrix}}{\begin{matrix}( Experience Importance + Skill Importance + \\ Currency Importance + Education Importance + \\ Certification Importance )\end{matrix}}$$

Experience Score: Numeric value calculated for each candidate indicating the degree of match between the candidate's experience (both required and desired skills) and the job requisition against which the candidate was compared.

Skill Level Score: Numeric value calculated for each candidate indicating the degree of match between the candidate's skill level (both required and desired skills) and the job requisition against which the candidate was compared.

Currency Score: Numeric value calculated for each candidate indicating the degree of match between the candidate's currency at each skill (both required and desired skills) and the job requisition against which the candidate was compared.

Education Score: Numeric value providing additional scoring points for candidates that have education levels in excess of the job request requirement. Additional scoring is only given if the job request indicates a desire for additional education.

Certification Score: Numeric value providing additional scoring points for candidates that have certifications in excess of the job request requirement. Additional scoring is only given if the job request indicates a desire for additional certifications.

Experience Importance: Value between 0.1 and 1.0 that represents the customer's opinion of the importance of experience with respect to the other 4 scoring items. In the above equation, the use of this importance factor in the denominator scales the resulting candidate score such that an exact match between a candidate and the job request results in a Candidate Score of 1.0.

Skill Importance: Value between 0.1 and 1.0 that represents the customer's opinion of the importance of skill level with respect to the other 4 scoring items. In the above equation, the use of this importance factor in the denominator scales the resulting candidate score such that an exact match between a candidate and the job request results in a candidate score of 1.0.

Currency Importance: Value between 0.1 and 1.0 that represents the customer's opinion of the importance of skill currency with respect to the other 4 scoring items. In the above equation, the use of this importance factor in the denominator scales the resulting candidate score such that an exact match between a candidate and the job request results in a candidate score of 1.0.

Education Importance: Value between 0.1 and 1.0 that represents the customer's opinion of the importance of education with respect to the other 4 scoring items. In the above equation, the use of this importance factor in the denominator scales the resulting candidate score such that an exact match between a candidate and the job request results in a Candidate score of 1.0. Scores in excess of 1.0 are possible for candidates that have education exceeding the job request requirement and meet or exceed all other requirements.

Certification Importance: Value between 0.1 and 1.0 that represents the customer's opinion of the importance of certification with respect to the other 4 scoring items. In the above equation, the use of this importance factor in the denominator scales the resulting candidate score such that an exact match between a candidate and the job request results in a Candidate score of 1.0. Scores in excess of 1.0 are possible for candidates that have certifications exceeding the job request requirement and meet or exceed all other requirements.

Experience Score

Experience Score=(ave(req_experience_scor)+ave(des_experience _scor)*1/(1+des_experience_weight))

req_experience_scor: Numeric value calculated for each candidate indicating the degree of match between the candidate's experience and the job requisition's required experience for each skill.

des_experience_scor: Numeric value calculated for each candidate indicating the degree of match between the candidate's experience and the job requisition's required experience for each skill.

des_experience weight: Number between 0 and 1 assigning the relative weight of the desired job skills with respect to the required job skills.

req_experience_scor math

1. If the applicant's months of experience level is less than or equal to the job requests required months of experience, the req_experience_scor for a given required skill is:

a. (applicant's experience/job requirement) * Experience Importance

2. If the applicant's months of experience level is greater than the job requests required months of experience, but less than the second break point value as defined in section 3.2.2.1.2, the req_experience_scor for a given required skill is:

a. 1.0+((applicant's experience-job requirement)/job requirement) * partial experience credit coefficient)) * Experience Importance

3. If the applicant's months of experience level is greater than the second break point as described in section 3.2.2.1.3, the req₁₃ experience_scor for a given required skill is:

a. (1.0+(second breakpoint value—job requirement) * partial experience credit coefficient) * Experience Importance

des_experience_scor math

1. If the applicant's months of experience level is less than or equal to the job requests desired months of experience, the des_experience_scor for a given required skill is:

a. ((applicant's experience/job desirement) * Experience Importance) * des_experience_weight

2. If the applicant's months of experience level is greater than the job requests desired months of experience, but less than the second break point value as defined in section 3.2.2.1.2, the des_experience_scor for a given required skill is:

a. (1.0+((applicant's experience—job desirement)/job desirement) * partial experience credit coefficient) * Experience Importance)) * des_experience_weight

3. If the applicant's months of experience level is greater than the second break point as described in section 3.2.2.1.3, the req_experience_scor for a given required skill is:

a. +(second breakpoint value—job desirement) * partial experience credit coefficient * Experience Importance)* des_experience_weight

The partial experience credit coefficient is a numeric value between 0 and 1 and allows a user to determine how much extra scoring credit candidates will receive for experience levels that exceed the job requirement.

Skill Level Score

Skill level Score=(ave(req_skill_level_scor)+ave(des_skill_level _scor)*1/(1+des_skill_weight))

req_skill_level_scor: Numeric value calculated for each candidate indicating the degree of match between the candidate's skill level and the job requisition's required skill level for each skill.

des_skill_level_scor: Numeric value calculated for each candidate indicating the degree of match between the candidate's skill level and the job requisition's desired skill level for each skill.

des_skill weight: Number between 0 and 1 assigning the relative weight of the desired job skills with respect to the required job skills.

req_skill_level_scor math

1. If the applicant's skill level is less than or equal to the job requests required skill level, the req skill_level_scor for a given required skill is:

a. (applicant's skill level/job requirement)) * Skill Importance

2. If the applicant's skill level is greater than the job requests required skill level, but less than the second break point value as defined in section 3.2.3.1.2, the req skill_level_scor for a given required skill is:

a. (1.0+(applicant's skill level—job requirement)/job requirement) * partial skill credit coefficient) * Skill Importance

3. If the applicant's skill level is greater than the second break point as described in section 3.2.3.1.3, the req skill_level_scor for a given required skill is:

a. (1.0+(second breakpoint value—job requirement) * partial skill credit coefficient) * Skill Importance

des_skill_level_math

1. If the applicant's skill level is less than or equal to the job requests desired skill level, the des_skill_level_scor for a given required skill is:

a. (applicant's skill level/job desirement)) * Skill Importance *

des_skill_level_weight

1. If the applicant's skill level is greater than the job requests desired skill level, but less than the second break point value as defined in section 3.2.3.1.2, the des_skill_level_scor for a given required skill is:

a. ((1.0+(applicant's skill level—job desirement)/job desirement) * partial skill credit coefficient) * Skill Importance) * des_skill_level_weight

2. If the applicant's skill level is greater than the second break point as described in section 3.2.3.1.3, the des_skill_level_scor for a given required skill is:

a. +(second breakpoint value—job desirement) * partial skill credit coefficient) * Skill Importance

3. The partial skill credit coefficient is a numeric value between 0 and 1 and allows a user to determine how much extra scoring credit candidates will receive for skill levels that exceed the job requirement.

Currency Score

Currency Score=(ave(req_currency_scor)+ave(des_currency_scor)*1/(1+des_currency_weight))

req_currency_scor: Numeric value assigned to each candidate depending upon whether the candidates skills associated with the job requests required skills are current

des_currency_scor: Numeric value assigned to each candidate depending upon whether the candidates skills associated with the job requests desired skills are current

des_currency_weight: Number between 0 and 1 assigning the relative weight of the desired skills currency with respect to the required skills currency.

req_currency_scor math

1. If the applicant's skills are current with respect to the Job request required skills, the req_currency_score for a given required skill is:

a. 1.0* Currency Importance

2. If the applicant's skills are not current with respect to the Job request required skills, the req_currency score for a given required skill is:

a. Customer determined value between 0 and 1 * Currency Importance

des_currency_scor math

1 . If the applicant's skills are current with respect to the Job request desired skills, the req_currency_score for a given required skill is:

a. 1.0 * des_currency_weight * Currency Importance

2. If the applicant's skills are not current with respect to the Job request desired skills, the req_currency_score for a given required skill is:

a. Customer determined value between 0 and 1 * des_currency_weight * Currency Importance

Education Score

The following table assigns a value to educational levels:

| Education Levels | Value |
|---|---|
| None | 0 |
| HS Grad | 1 |
| Associates | 2 |
| Bachelors | 3 |
| Masters | 4 |
| PhD | 5 |

1. Candidate filtering will eliminate all candidates with less than the required education from the scoring engine. All candidates whose education level meets the job requirement will receive an Education Score of:

a. 1.0 * Education Importance

2. If the Job request includes a desired education level in addition to the required (e.g. “bachelors degree required, masters degree desired”), and a candidate has the desired education level, the candidate will receive and Education Score as follows:

a. (1.0+(desired level-required level) * partial education credit coefficient) * Education Importance

3. If the Job request does not include a desired education component, candidates will not receive additional scoring credit even though their education level exceeds the Job request requirement and the Educational Score will be:

a. 1.0 * Educational Importance

The partial education credit coefficient is a numeric value between 0 and 1 and allows a user to determine how much extra scoring credit candidates will receive for education levels that exceed the job requirement.

Certification Score

Candidate filtering will eliminate all candidates with less than the required certification from the scoring engine.

1. If the Job request includes desired certifications in addition to the required (e.g. “PMI, CCNA, and MSCE certifications desired), the Certification Score will be as follows

2. (number of desired certifications candidate possesses/number of desired certification) * Certification Importance.

3. If a candidate has additional certifications, but the job requests does desire them, no credit is given.

dR Selection

Description

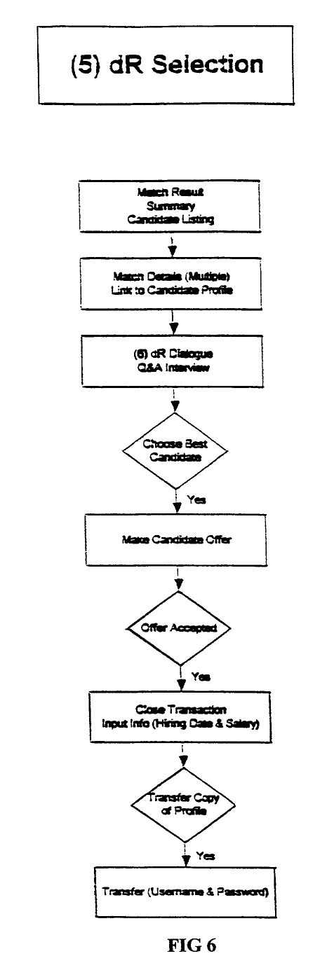

Now referring to FIG. 6, the invention can provide all the information and the necessary tools to accurately hire the best candidate. Specifically, this invention gives detailed match results and summaries as to how well every matched candidate met defined criteria, provides reports and statistics, and a closing transaction process that provides the employer hiring process management tools by keeping important information such as hiring date and salary. The closing process also includes a function to transfer a copy of the profile to the hiring company for tracking and management purposes.

These tracking features act as tools to allow managers and HR professionals to manage and coordinate addition steps in the hiring process. The Preferred Pool feature allows those involved in the hiring process to select candidates that are being considered for the position and put them in a list. This list helps the user keep track of the “best” candidates for the position. The Tracking Center feature allows users to keep a log of when activities occur that are steps in the selection/hiring process. It allows for easy communication between management and HR because clients can set security to allow both types of users to access and edit the data as needed.

Design

Access to Preferred Pool and Tracking Center

1. Users who have access to job requests will also have access to the corresponding Preferred Pool and Tracking Center.

2. Users who have access to view a job request may also view its pool and tracking center. Users who have access to edit a job may also edit the pool and tracking center (this includes the ability to add members and add new rows in the tracking center).

Preferred Pool

1. Users may add profiles to the Preferred Pool from several different entry points.

2. Profiles may be added directly from the match list or from the match preview screen for a selected match list profile.

3. Profiles may be added directly from a search list or from the preview screen for a selected search list profile.

4. By accessing the Preferred Pool page, profiles may be added from a user's “Bookmarks” or may be added by simply typing in the Profile ID.

5. Profiles may also be removed from the pool via the Preferred Pool page, however, profiles may not be removed once a user has added an action in the tracking center for that profile.

Tracking Center

1. Users may record multiple steps in the hiring process for some or all of the profiles in the preferred pool

2. The page will have the following columns of information: Profile/Candidate Name, Action Date, Action, Source Code, User, and Comments.

3. The Profile/Candidate Name column will be a drop down list of the candidate names from the preferred pool for that job. If the candidate name is not available (due to the profile preferences having the privacy enabled) we will display the profile name instead.

4. The action date will be a date/time field. When a user adds a new activity, the date will default to the current date/time but will be editable to the user.

5. The action field will be a drop down list of possible activities in the hiring process such as “phone screen”, “interview”, and “reference check”. The system will be delivered with an initial set of values and clients will be able to add additional values to the table via the setup table maintenance option under system tools.

7. There will be one delivered value in the action table for “Source”.

8. If the “Source” value has been selected in the Action field, the source code field will be available with a drop down list of options. The Source Code field will be unavailable (gray) unless the “Source” option has been selected. The system will be delivered with an initial set of values, such as “match list”, “employee referral”, and “website”, but clients will be able to add additional values to the table.

9. The source field will default to the value in the Candidate_Profile table in the Source code field.

10. The User field will default to the user name of the user initiating the activity but will be editable to the user.

11. The Comments field will be a short field (50 char.) for the user to enter free text as necessary.

12. Users can add new activities by clicking on the “New” button. When a user clicks on this button, it will create a new blank row for them to enter data. They may click on the new button multiple times prior to clicking the “Save” button.

13. The page will display the list of activities sorted by Profile and then by action date.

14. The table where the tracking center data is stored should also store when the action was recorded (update datetime stamp) and who actually made the change (candidate update ID).

Use Cases

Use Case 1: Populate Preferred Pool from Match List

Users will be able to select “interesting” candidate profiles from a match list to add to the “Preferred Pool” of candidates for a selected Job Request. Following are execution steps:

1. The user logs on to the application.

2. Selects the Job Request view on the Activity Hub.

3. Clicks on the Last Match Returned number for one of the active Job Requests listed.

4. Match List is displayed.

5. User clicks on the Profile ID to link to the Match Preview page.

6. User reviews page then clicks “Back” to return to the Match List.

7. User repeats steps 6 and 7 for each Profile on the list.

8. User selects candidates that are interesting enough he/she would like to “keep” them for consideration.

9. User clicks on the check-box by the desired Profiles and then clicks the “Add to Pool” button to add them to the “preferred profile pool” for that Job Request.

10. User clicks on the “Back to Activity Hub” button to leave the page.

Use Case 2: Populate Preferred Pool from Search List

Users will be able to select “interesting” candidate profiles from a search list to add to the “Preferred Pool” of candidates for a selected Job Request. Execution Steps include:

1. The user logs on to the application.

2. Selects the menu option: Tools-Search-Profiles.

3. User enters Search Criteria and initiates search.

4. Search Results page is displayed.

5. User clicks on the Profile ID to link to the Display Profile page.

6. User reviews page then clicks “Back” to return to the Search Results page.

7. User repeats steps 6 and 7 for each Profile on the list.

8. User selects candidates that are interesting enough he/she would like to “keep” them for consideration.

9. User clicks on the “Add to Pool” button by a desired Profile.

10. Page is displayed that lists all the Job Requests the user has access to Edit.

11. User clicks the check box next to each Job Request for which the Profile should be added.

12. User clicks the “Add to Pool” button.

13. User is returned to Search Results page.

Use Case 3: Reviews Preferred Pool for a Job Request via Activity Hub

Users will be able to view the members of the preferred pool for a specific Job Request from the Activity Hub. Execution steps include:

1. The user logs on to the application.

2. Selects the Job Request view on the Activity Hub.

3. User clicks on the folder icon by the Request Name for a particular Job Request.

4. A list of members is displayed directly beneath the Request Name.

5. The list contains the Profile ID and Profile Name and Candidate Name if available (based on profile preferences).

6. The user clicks on the Profile ID and the Display Profile page is displayed for that profile.

Use Case 4: Adds/Removes member of Preferred Pool

Users will be able to add and remove members of a Preferred Pool for a Job Request. Execution steps include:

1. The user logs on to the application.

2. Selects the Job Request view on the Activity Hub.

3. User clicks on the Job Request ID for a particular Job Request.

4. The Administrative Center for that Job Request is displayed.

5. User selects the menu item: Tools-Preferred Pool.

6. Preferred Pool page is displayed.

7. User selects a candidate from the Preferred Pool list and clicks on the “Remove from Pool” button.

8. Selected candidate is removed from the Preferred Pool list.

9. User selects a candidate from the Bookmarks list and clicks on the “Add to Pool” button.

10. Candidate now appears in the Preferred Pool list (as well as remaining in the Bookmarks list).

Use Case 5: User reviews Tracking Center for selected Job Request

Users will be able to view and edit applicant tracking data for a specified Job Request. Execution steps include:

1. The user logs on to the application.

2. Selects the Job Request view on the Activity Hub.

3. User clicks on the Job Request ID for a particular Job Request.

4. The Administrative Center for that Job Request is displayed.

5. User selects the menu item: Tools-Tracking Center.

6. The Tracking Center page is displayed.

7. User views list of candidates and activities for each.

Use Case 6: Candidate selected to fill Job Request

User will be able to close a Job Request and indicate the selected candidate from the Tracking Center. Execution Steps include:

1. The user logs on to the application.

2. Selects the Job Request view on the Activity Hub.

3. User clicks on the Job Request ID for a particular Job Request.

4. The Administrative Center for that Job Request is displayed.

5. User selects the menu item: Tools-Tracking Center.

6. The Tracking Center page is displayed.

7. User views list of candidates and activities for each.

8. User clicks on the red “light” icon to close the request.

9. Inactivation dialog box is displayed.

10. User completes the dialog box. Candidate ID field is prompted by the Preferred Pool list of candidates.

dR Dialogue

Description

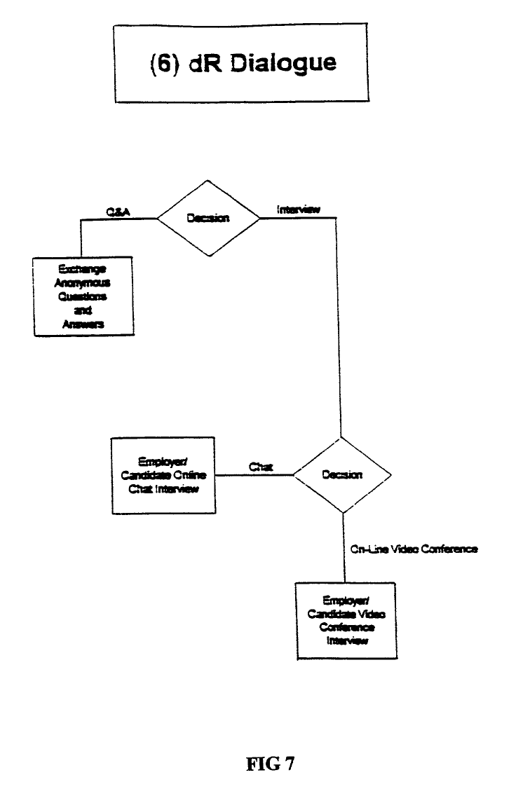

Now referring to FIG. 7, the invention can provide an environment for communication that supports the hiring process for involved parties (employers and candidates). Specifically, this invention provides involved parties (employers and candidates) a forum where they can exchange anonymous question and answer sessions, and conduct online interviews via real-time chat and/or video conferencing. This invention provides a simple communication system, where each involved parties (employers and candidates) can reach the other without having to retrieve contact information.

Design/Use Case

Messaging Center

1. When a user clicks on the Message Alert either from the Request or Profile Summary view or the Match summary, a Messaging Center screen will be displayed.

2. The Messaging Center will display the profile or request ID that originated the message.

3. This ID will be a hyperlink to take the user to the Message History screen. The ID will appear in bold or be somehow visually distinguishable if there are unread messages.

4. The Messaging Center will display the name of the profile or request, provided the owner of that profile has not listed the name as private.

5. There will be a column for the number of Unread Messages and a column for Total Messages.

Message History

1. When the user clicks on the profile or request ID on the Messaging Center screen, the Message History screen will be displayed.

2. Near the top of the screen it will indicate “Message History from . . . ” with the request or profile name and the name (provided the name is not privacy protected by its owner.)

3. There will be a column that indicates the subject line of the message and a column that indicates the date/time stamp of when the message was sent.

4. The Messaging History will indicate all messages sent to that request or profile and all those received from it. They will be sorting by the date/time with the most recent at the top.

5. The rows will be color coded so that the user can see at a glance if the message was sent or received.

6. The rows will appear in a bold font if they are unread.

7. The message “subject” will be a hyperlink that takes the user to the actual message.

8. A user should be able to delete a message if desired.

dR Negotiation

Description

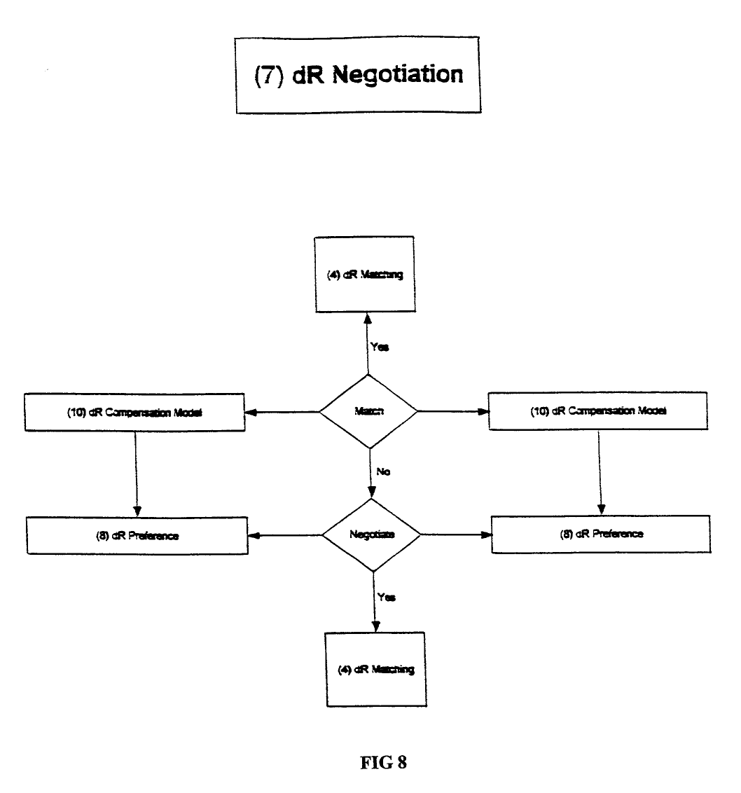

Now referring to FIG. 8, the invention can provide an automated compensation negotiation process for the involved parties (employers and candidates). Specifically, this invention utilizes the allowed compensation variations defined in preferences (8) of involved parties (employers and candidates) to match compensation proposals (10) in the matching (4) process, diminishing the human interactions and inter-personal influences by the candidate. The involved parties (employers and candidates) can modify their allowed compensation variations at any time.

This feature allows employers to manage their labor and hiring costs. Employers can seek the lowest available salary or rates among the best-ranked candidates. Prior to entering into verbal negotiations, the users can select the candidates that best fit within their budget. This feature allows candidates to find the optimum value for their services. Prior to entering verbal negotiations for the salary or compensation, the candidate can select the match that best fit objectives

dR Preference

Description

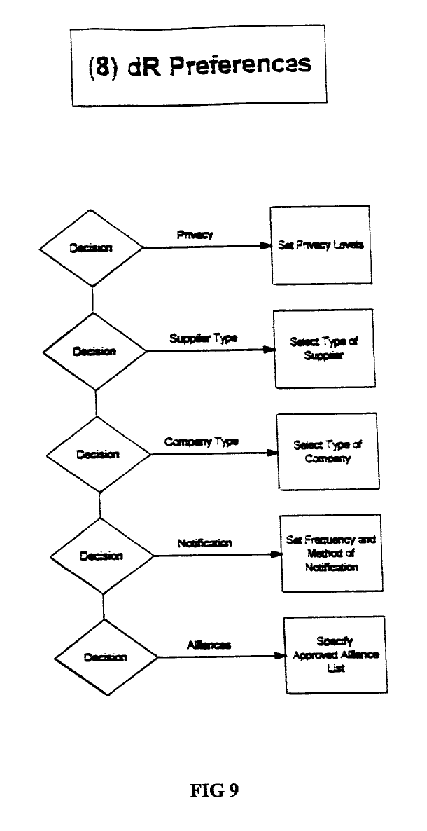

Now referring to FIG. 9, the invention can provide involved parties (employers and candidates) a means of setting specific preferred criteria. Specifically, involved parties (employers and candidates) can determine their levels of privacy, types of suppliers (such as consulting firm consultants, contractors, and candidates), types of companies (such as private, C-class, minority owned, and woman owned), frequency and method of notifications, user-defined alerts, profile status (active, inactive), global logistics and alliances (preferred associated relationships). This invention also allows setting of default and/or customized preferences per transaction.

Design/Use Case

Preferences—Preferences in this context refer primarily to user selected options for the handling of their requests, profiles, match notifications, user defined alerts, privacy levels, profile status, global logistics and preferred associate relationships.

Privacy—Privacy options allow the demand and supply side to control the level of information that is released as a result of the match/search process. The information items to select for showing or hiding are: Name, Phone, Email, URL, Address, Fax, and Contact. The categories are applied to both job requests (Company Information) and profiles (Candidate Information). The default can be to show all information. The user can select by any or all of the items from the list to hide.

Logistics

1. Frequency of e-mail match notification: How often will the match results be e-mailed to recipients.

2. The user will have a set list of choices: every 1, 3, 8, or 24 hours or every 156 hours (once a week).

3. All existing matches will be sent in each email (up to a maximum specified).

4. Profiles that have been submitted in a previous e-mail will be flagged.

5. Maximum number of results per match per profile: This refers to number of matches per request or per profile.

6. The candidate or employer will receive an email at the frequency they have chosen.

7. The email will contain a list of all candidate codes that have matched their active requests (employer) or all the job requests for which they have been matched and submitted (candidate).

8. The size of the list included in the email will be limited to the number chosen in the “Maximum Number” field.

9. This will indicate the maximum number of responses PER active request or PER active profile in the system.

10. A candidate with 4 active profiles in the system who has chosen a Max. Number of “10” will receive an email with 0* to 40 items on the list. An employer with 20 requests in the system who has chosen a Max. Number of “10” will receive an email with 0* to 200 candidate codes.

dR Apply

Description

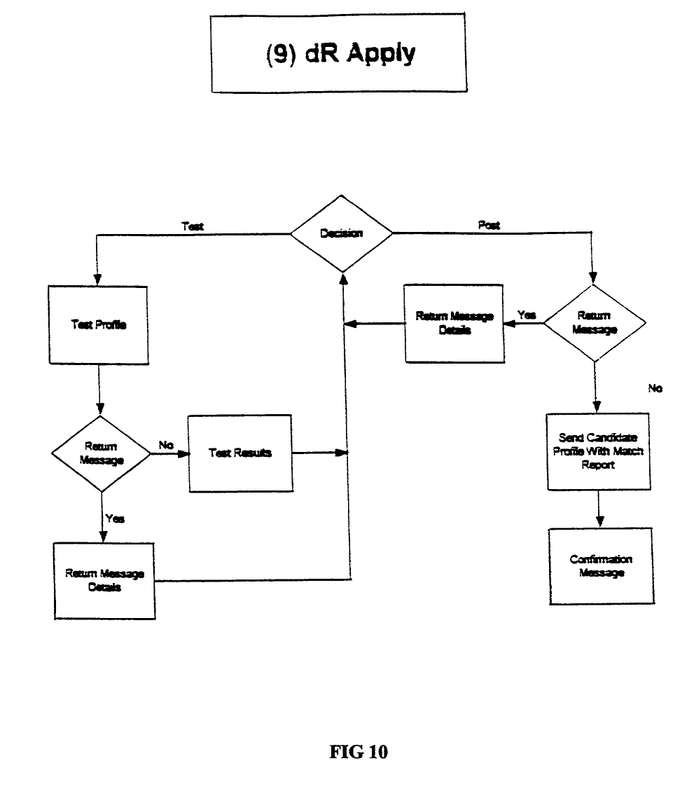

Now referring to FIG. 10, the invention can provide candidates control over their profile submission. Specifically, this invention allows candidate to test and/or post profile to a specific chosen job posting. A detailed match result as to how well the candidate met defined criteria is sent to the employer along with the candidate profile. This invention also returns applications for candidates that don't match the minimum requirements for the job posting giving them specific details about missing minimum requirements.

Design/Use Case

Log-on Process

1. Two ways to access the database: either via the intranet website or via one or more external website(s). When users go to the internal website, they are required to enter their previously assigned logon credentials (user ID and password). When users go to the external website, they are allowed to sign-up as a new user or use an existing logon if they have already signed up.

2. The new user have to indicate the following information: First Name*, Last Name*, Middle Initial, E-mail*, User Name*, Address1, Address2, Country, State, City, Postal Code, Phone, Ext., Alternate, Ext., Fax, Ext., URL. The fields with * are required.

3. There is logic to ensure that they select a unique user name. Users are allowed/required to select their own password.

4. Users that are established via the sign-up process are automatically assigned to the specified default OU and put in the specified default Role.

5. Once the sign-up process has been completed, the user is automatically authenticated (for this session only).

6. If an external candidate is hired and the company wants to turn them into an internal user, they can do so by accessing the userID via the User setup screen and changing the OU and Role from the external defaults to other values that are valid for that company. Both must be changed before the record can be saved. This will be considered an MOU “Transfer” and all related information will be transferred over (as detailed in the MOU document.)

Job Requests

1. Job Requests can only be created and modified by Internal users.

2. There is a button at the top of the Job Request Administrative Center (near the activation buttons) that indicates “Export Job Request”.

3. When the user has completed the request and is ready to activate it, he/she will push this button, and a copy of the request will be sent to the external site and become available to applicants.

4. Any time users choose to close a request by completing the inactivation dialog or expiration dialog, they will also need to make arrangements for having the external version removed from any and all external sites.

Profiles

1. When users access the application and browse through available jobs, they can “apply” for the jobs by completing a Profile.

2. Each job on the web site has a button/link that says “Apply for this Position”.

3. The user information is auto-populate based on what was provided during the sign-up process. Additional information being auto-populated: the Desired Location 1 with the Location in the job request and the Desired Position and Level with the related information in the job request. Although these fields are auto-populated, the information is editable by the applicant.

4. At the bottom of the screen, there are three buttons: “Submit My Application”, “Complete Detailed Profile”, and “Cancel”.

5. When the user clicks on either button (excluding the Cancel), the Profile will be activated (set to “green” status). Also, a copy of the Profile can be made in the database. This new Profile will have a Candidate_Profile_ID equal to the Job_Request_ID of the Job Request for which they are “applying”.

6. Regardless of which link the user clicks (either the “Submit My Application” or “Complete Detailed Profile” button), the profile will go into the pool of active “external” profiles and will therefore be available for matching against any job request that has at some time been “Exported” (derived as a Job Request with the Exported flag set to Yes.

7. When the user clicks on the “Complete Detailed Profile” button, the complete Profile Administrative Center (with the complete skills tree and work history section) is displayed so that the user can indicate a more complete profile and thus possibly matches against more open positions.

8. There will be a test/submit button on this Profile and when a user clicks on it, any information that is completed will be copied over to the Profile.

dR Compensation Model

Description

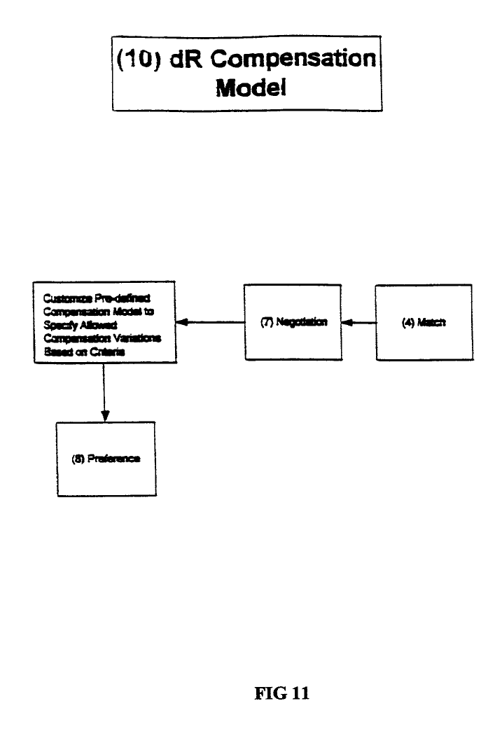

Now referring to FIG. 11, the invention can be customizable predefined compensation model to specify allowed compensation variations upon criteria. Specifically, this invention allows involved parties (employers and candidates) to establish a specific compensation pattern to be used by the matching (4) and negotiation (7) to reduce the human interaction between involved parties (employers and candidates) to lead to a compensation agreement.

The digitalReach application provides a precision matching engine that suggests a good fit between job requests and employee or candidate profiles based on several factors. One of the matching factors is “Compensation”. The system has fields for employees/candidates to indicate salary requirements and for employers to indicate an acceptable “willing to pay” range. Matching engine will only suggest a match if the profile's required salary falls within the acceptable range.

Design/Use Case

Candidate Compensation

1. There is a section on the Personal Profile screen designated as “Minimum Desired Compensation”.

2. There is a check box on the screen labeled “Hide from other Users”. This box will default to “Yes” but can be changed by the owner of the Profile.

3. Setting this box to “Yes” indicates that although the Compensation data will be used as part of the matching process, no other users will have access to view the data. If another user looks at the profile either via a match list or a search, this information will be hidden.

4. There is a field in the Minimum Desired Compensation section to indicate the Minimum Base Required.

5. There is a drop-down field next to the “Minimum” to indicate the frequency that goes with that minimum with values of: Hourly, Monthly, and Annually.

6. In the “Frequency” drop-down box, the labels for Hourly and Monthly indicates the associated constant, used in the “Annualizing” calculation. (Such as “Hourly (2080)” and “Monthly (12)”.)

7. There is a field to indicate Minimum Bonus %.

8. There is a field to indicate Total Compensation. This field annualizes sum of the Minimum Base plus the Minimum Bonus %.

9. If the Minimum Base has a frequency of “Hourly” it is multiplied by 2080 to get to the annual equivalent.

10. If the Minimum Base has a frequency of “Monthly” it is multiplied by 12 to get to the annual equivalent.

11. These constants are stored in a parameters table and may be modified by the system administrator at the point of installation.

12. There are operators displayed between the fields to help describe the calculation of the total compensation fields.

13. The bonus percent amount is calculated off the annualized base amount.

14. There are mouse-overs in this section consistent with other mouse-overs in the application.

15. There is a column to indicate Commission Percentage (what percentage of the total compensation is expected to be based on commission) following the Total Comp column. This is not factored into the Total Comp calculation.

Employer Compensation

1. There is a section on the Job Request screen designated as “Proposed Compensation”.

2. There is a field in the Compensation section to indicate the Base Range Minimum and the Base Range Maximum.

3. There is a drop-down field next to the Base Min and Max to indicate the frequency that goes with that amount with values of: Hourly, Monthly, and Annually.

4. In the “Frequency” drop-down box, the labels for Hourly and Monthly will indicate the associated constant, used in the “Annualizing” calculation. (Such as “Hourly (2080)” and “Monthly (12)”.)

5. There is a field to indicate the expected or available Bonus % amount (if any).

6. There is fields to indicate the Total Compensation Min and Max. These fields are based on the annualized amounts.

7. If the min/max base has a frequency of “Hourly” we will multiply by 2080 to get to the annual equivalent.

8. If the min/max base has a frequency of “Monthly” we will multiply by 12 to get to the annual equivalent.

9. These constants are stored in a parameters table and may be modified by the system administrator at the point of installation.

10. There are operators displayed between the fields to help describe the calculation of the total compensation fields.

11. The bonus percent amount is calculated off the annualized base amount.

12. There are mouse-overs in this section consistent with other mouse-overs in the application.

13. There is a column to indicate Commission Percentage following the Total Comp column. This is not factored into the Total Comp calculation.

dR Multiple Organizational Units (M.O.U)

Description

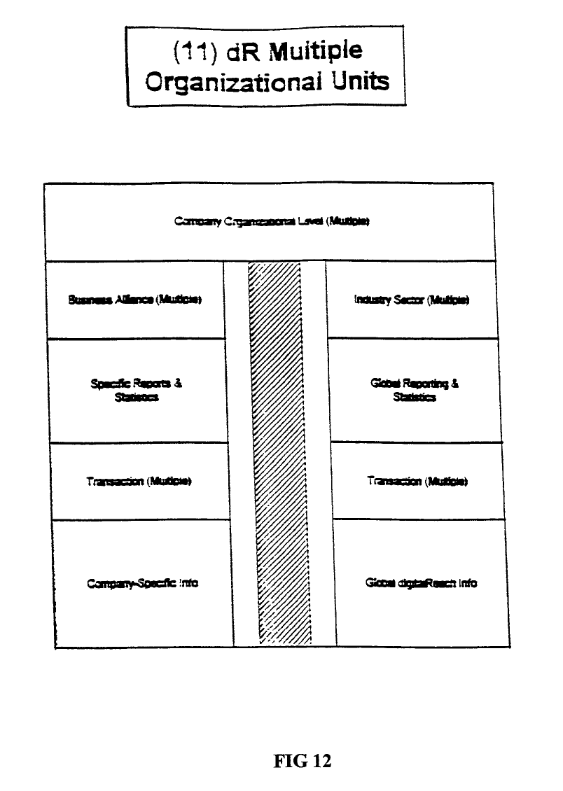

Now referring to FIG. 12, the invention can be a global foundation on which all other modules reside and depend on. Specifically, this invention allows for the support of most types of organizational structure (multiple organizational levels) such as multiple companies (or consolidation of company), locations, divisions, departments, multiple business alliances and partnerships. The framework supports multi-company and regional entities as well. Operational views, global reporting of transactions and statistics for system demographics such as industry sectors, skills, logistics and activity management for the above is integral part of the application.

Having the capability of handling Multiple Organization Units (MOU) is a critical aspect of the management of Job Requests and personal profiles in the intranet environment. Each organization has it's own structure and the product accommodates this by being very flexible in how the company's physical structure is logically represented in the digitalReach system. The system allows for simplicity in the set up of the organization as a number of individuals may be participating in the process.

DigitalReach's flexible MOU system:

1. Logically represent the client organization.

2. Flexible and generic enough to meet the needs of most businesses without customization.

3. Flexible enough to support a non-hierarchical matrix organization.

4. Work within the Security Model to limit user access to information based on their assigned Organization Unit (OU).

Design

The system has an Enterprise Setup tool. This is the entry point for creation and manipulation of the organizational structure. A System Administrator begins the process by creating the Top Level OU. The administrator will have the option of completing the Enterprise set up process or turning the rest of the set up over to the managers of the OUs that need to be created. The OU manager can enter registration information for his OU and create subordinate OUs if he has the appropriate privileges. Ability to create OU will be controlled by assigned roles.

Each OU that is created is registered, that is, populated with required and optional information. That information include, OU name, internal OU designation (i.e. Cost Center number), OU Manager, company information (can be copied from upper levels) and create personnel for the OU. A system generated OU ID number will link the various OUs in their proper hierarchy.

1. OU Managers

a. Each OU has one designated OU Manager.

b. The OU manager is assigned after the OU has been created (User IDs require that an OU be specified when the User ID is created).

c. When an OU manager is assigned, the action will be logged.

2. Top Level OU

a. Each MOU structure begins with a Top Level Organization Unit.

b. The Top Level OU can only be created by an intraReach Administrator (IR Admin).

c. When a Top Level OU is created, the creator/date is logged as part of the creation process.

3. Parent Ous

a. An OU that has lower level OUs assigned underneath it is understood to be a Parent OU.

b. If permission is granted (through assignment of the appropriate role), an OU Manager of a Parent OU can modify information contained in Child OUs existing beneath the Parent OU.

c. Child OUs inherits designated data from their Parent OU.

d. Fields containing data that is inherited by Child OUs will be clearly marked.

4. Child Ous

a. When a Child OU is created, the creator/date is logged as part of the creation process.

b. Any OU that is not designated as a Top Level OU is understood to be a Child OU.

c. A Child OU must be assigned to a Parent OU.

d. A Child OU is linked to its Parent OU.

e. A Child OU is inherit designated information from its Parent OU.

5. OU Members

a. Each user is assigned to one OU (To support matrix organizations the system allows one user to be assigned to multiple OUs, but have only one username/password). The user is then understood to be a member of that OU.

6. Moving OU Members

a. An OU member can be moved from one OU to another OU.

b. In order for an OU member to be transferred to another OU, they must be designated as available to transfer.

c. When an OU Member is transferred from one OU to another OU, the transaction is logged.

d. In order to move an employee from one OU to another, the employee's current manager accesses the “Transfer” item under the Administration option.

e. When selected, the OU manager is presented with a window with two I-frames: one list shows the employees (that is “Users”) that are currently in his/her OU and the other shows a list of all OU's.

f. The manager will select the employee that needs to be moved and select the proper OU.

e. Completion of these two steps results in a change to the “Member of” OU on the userID screen for that user. It will also “transfer” all the profiles and any related data (such as EEO data) belonging to that user to the new OU.

7. Job Requests

a. When a Job Request is created, the creator/date is logged as part of the creation process.

b. The creator of a Job Request can be different than the owner of the Job Request.

c. There is a field on the Job Request in the “General Information” section for the user to select the proper OU for the Request. The OU selected is the OU of which the selected candidate is a member.

d. The user is able to pick the OU from a list of OU's that user has access to.

e. An OU member may be able to create Job Requests for their OU Manager, if their assigned role grants them permission to do so.

f. An OU member may be able to release Job Requests (activate) if their assigned role grants them permission to do so.

g. An OU member cannot activate Job Requests if their assigned role does not grant them permission to do so.

Use Case

Organization Unit Initial Creation Use Case #1

1. Designate an intraReach Administrator (IR Admin).

2. IR Admin creates Roles.

3. IR Admin creates top-level Organization Unit (OU).

4. IR Admin creates next level of OUs (Children).

5. IR Admin continues to create Child OUs until the organization has been is completely represented.

6. IR Admin creates User Ids for all known organization members.

7. IR Admin designates the Top Level OU Manager.

8. IR Admin/Top Level OU Manager designates Child OU Managers.

a. Child OU Managers can designate managers for their own OU's children.

b. Child OU Managers can create children for their own OU if permission to create children has been granted by their assigned role.

c. Child OU Managers cannot designate managers for OUs not existing in the tree structure underneath their own OU.

d. Child OU Managers cannot create Child OUs for OUs not existing in the tree structure underneath their own OU.

[chemical structure]

Organization Unit Initial Creation Use Case #2

1. Designate an intrareach Administrator (IR Admin).

2. IR Admin creates Roles.

3. IR Admin creates top-level Organization Unit (OU).

4. IR Admin creates User ID(s) for the Top Level OU.

a. IR Admin assigns each User ID a role.

b. IR Admin assigns each User ID to the Top Level OU.

c. IR Admin designates Top Level OU Manager.

5. IR Admin/Top Level OU Manager creates next level of OUs (Children).

6. IR Admin/Top Level OU Manager creates User ID(s) for the Child OUs.

a. IR Admin/Top Level OU Manager assigns each User ID a role.

b. IR Admin/Top Level OU Manager assigns each User ID to a Child OU.

c. IR Admin/Top Level OU Manager designates Child OU Managers.

7. IR Admin/OU Manager/Child OU Manager creates the next level of Child OUs.

8. IR Admin/Top Level OU Manager/Child OU Manager creates User ID(s) for the Child OUs.

a. IR Admin/Top Level OU Manager/Child OU Manager assigns each User ID a role.

b. IR Admin/Top Level OU Manager/Child OU Manager assigns each User ID to a Child OU.

c. IR Admin/Top Level OU Manager/Child OU Manager designates Child OU Managers.

Repeat OU creation/User ID creation/Manager assignation until the entire organization is represented.

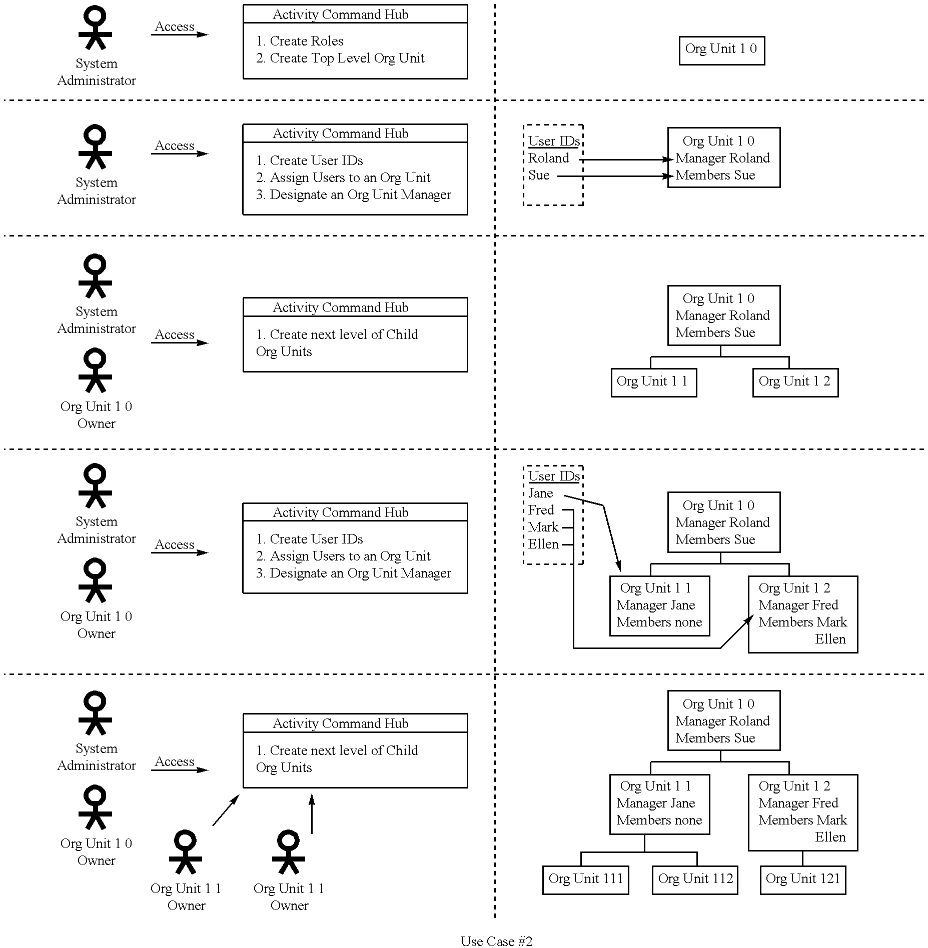

The discussion included in this United States Patent Application is intended to serve as a basic description of the invention. The reader should be aware that the specific discussion may not explicitly describe all the embodiments of the invention that are possible; many alternatives are implicit. It also may not fully explain the generic nature of the invention and may not explicity show how each feature or element can actually be representative of a broader function or of a great variety of alternative or equivalent elements. Again, these are implicitly included in this disclosure. Where the invention is described in fuctionally-oriented terminology, each aspect of the function can be accomplished by a device, subroutine, or program. Apparatus claims may be included to address the functions the inventions and each element performs. Neither the description not the terminology is intended to limit the scope of the claims.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “match element” should be understood to encompass disclosure of the act of “matching”—whether explicitly discussed or not—and, conversely, were there only disclosure of the act of “matching”, such a disclosure should be understood to encompass disclosure of a “match element” and even a means for “matching” Such changes and alternative terms are to be understood to be explicitly included in the description.

Additionally, various combinations and permutations of all elements of applications can be created and presented. All can be done to optimize the design or performance in specific applications.

Any acts of law, statutes, regulations, or rules mentioned in this application for patent; or patent, publications, or other references mentioned in this application for patent are hereby incorporated by reference herein. Specifically, United States Provisional Patent Application No. 60/210,206 filed on Jun. 8, 2000 is hereby incorporated by reference herein.

In addition, as to each term used it should be understood that unless its utilization in this application is inconsistent with such interpretation, common dictionary definitions should be understood as incorporated by reference for each term and all definitions, alternative terms, and synonyms such as contained in the Random House Webster's Unabridged Dictionary, second edition are hereby incorporated by reference. However, as to each of the above, to the extent that such information or statements incorporated by reference might be considered inconsistent with the patenting of this/these invention(s) such statements are expressly not to be considered as made by the applicant(s).

Thus, the applicant(s) should be understood to claim at least: i) a human resources assessment system as herein disclosed and described, ii) a computer configured as herein disclosed and described, iii) subroutines and programs as herein disclosed and described, iv) the related methods disclosed and described, v) similar, equivalent, and even implicit variations of each of these systems and methods, vi) those alternative designs which accomplish each of the functions shown as are disclosed and described, vii) those alternative designs and methods which accomplish each of the functions shown as are implicit to accomplish that which is disclosed and described, viii) each feature, component, and step shown as separate and independent inventions, ix) the applications enhanced by the various systems or components disclosed, x) the resulting systems and output produced by such systems or components, and xi) the various combinations and permutations of each of the above.

We claim:

1. A method of matching the valuation of individuals to valuation requirements, comprising the steps of:
a. generating at least one individual valuation profile;
b. aggregating said at least one individual valuation profile;
c. establishing minimum valuation requirements;
d. generating filtering parameters corresponding to said minimum valuation requirements;
e. matching said at least one individual valuation profile to said minimum valuation requirements;
f. aggregating individual valuation profiles having at least said minimum valuation requirements.

2. The method of matching the valuation of individuals to valuation requirements as described in claim 1, wherein said step of generating filtering parameters corresponding to said minimum valuation requirements comprises generating filtering parameters from the group consisting of a profile status parameter, a position level parameter, a location parameter, an availability parameter, a travel parameter, a certifications parameter, an education parameter, a compensation parameter, and a required skills parameter.

3. The method of matching the valuation of individuals to valuation requirements as described in claim 2, wherein generating said required skills parameter comprises selecting a subcategory of skills from a skill library.

4. The method of matching the valuation of individuals to valuation requirements as described in claim 2, further comprising the step of adjusting filtering parameters.

5. The method of matching the valuation of individuals to valuation requirements as described in claim 4, wherein said step of adjusting filtering parameters comprises:
a. inputting a latest start date; and
b. inputting a duration of time after said latest start date.

6. The method of matching the valuation of individuals to valuation requirements as described in claim 4, wherein adjusting filtering parameters comprises inputting a maximum travel percentage.

7. The method of matching the valuation of individuals to valuation requirements as described in claim 4, wherein adjusting filtering parameters comprises:
a. inputting a maximum annual compensation amount; and
b. inputting a percentage greater than said maximum annual compensation amount.

8. The method of matching the valuation of individuals to valuation requirements as described in claim 4, wherein adjusting filtering parameters comprises inputting minimum skill valuation requirements against said subcategory of skills from said skill library.

9. The method of matching the valuation of individuals to valuation requirements as described in claim 4, further comprising the step of refiltering said at least one individual valuation profile.

10. The method of matching the valuation of individuals to valuation requirements as described in claim 1, further comprising the step of scoring filtered individual profiles using individual valuation profile score elements.

11. The method of matching the valuation of individuals to valuation requirements as described in claim 10, wherein individual valuation profile score elements are selected from the group consisting of required skill experience, desired skill experience, required skill level, desired skill level, required skill currency, desired skill currency, desired education, and desired certifications.

12. The method of matching the valuation of individuals to valuation requirements as described in claim 10, further comprising the step of adjusting score calculation parameters.

13. The method of matching the valuation of individuals to valuation requirements as described in claim 12, wherein said step of adjusting score calculation parameters comprises adjusting scoring parameters selected from the group consisting of excess skill experience cap, excess skill experience score, excess skill level score, current skill score, excess education score, non-current skill score, desired skills score, and desired certifications score.

14. The method of matching the valuation of individuals to valuation requirements as described in claim 12, further comprising the step of setting breakpoints in said score calculation parameters.

15. The method of matching the valuation of individuals to valuation requirements as described in claim 14, further comprising the step of weighting said score calculation parameters.

16. The method of matching the valuation of individuals to valuation requirements as described in claim 15, further comprising the step of rescoring said filtered individual profiles based upon adjusted score calculation parameters.

17. The method of matching the valuation of individuals to valuation requirements as described in claim 10, further comprising the step of assigning importance to said individual valuation profile score elements.

18. The method of matching the valuation of individuals to valuation requirements as described in claim 17, further comprising the step of triggering a dialog function.

19. An apparatus to match the valuation of an individual to valuation requirements, comprising:
a. at least one individual valuation profile;
b. an individual valuation profile aggregation element;
c. an individual valuation profile filter element having adjustable filtering parameters;
d. a minimum valuation requirements match element; and
e. a matched individual valuation profile aggregation element.

20. The apparatus to match the valuation of an individual to valuation requirements as described in claim 19, wherein said adjustable filtering parameters are selected from the group consisting of a profile status parameter, a position level parameter, a location parameter, an availability parameter, a travel parameter, a certifications parameter, an education parameter, a compensation parameter, and a required skills parameter.

21. The apparatus to match the valuation of an individual to valuation requirements as described in claim 19, further comprising individual valuation profile score elements, whereby matched individual valuation profiles are ranked.

22. The apparatus to match the valuation of an individual to valuation requirements as described in claim 21, wherein said individual valuation profile score elements are selected from the group consisting of required skill experience, desired skill experience, required skill level, desired skill level, required skill currency, desired skill currency, desired education, and desired certifications.

23. The apparatus to match the valuation of an individual to valuation requirements as described in claim 21, further comprising importance functions assignable to said individual valuation profile score elements.

24. The apparatus to match the valuation of an individual to valuation requirements as described in claim 23, further comprising a dialog function.
